(19) United States
(12) Patent Application Publication
(10) Pub. No.: US 2019/0110514 A1
(43) Pub. Date: Apr. 18, 2019

(54) KITS COMPRISING SATIETY-INDUCING FORMULATIONS

(71) Applicant: PERORA GMBH, Heidelberg (DE)

(72) Inventor: Dirk VETTER, Heidelberg (DE)

(21) Appl. No.: 15/999,286

(22) PCT Filed: Feb. 17, 2017
(86) PCT No.: PCT/EP2017/053713

§ 371 Date: Aug. 17, 2018

(30) Foreign Application Priority Data
Feb. 18, 2016 (EP) 16156372.1

(51) Int. Cl. A23P 10/22; A23L 33/12; A23L 33/24; A23L 33/15; A23L 33/16; A23L 33/19; A23L 33/185; A23L 7/126; A23P 20/10; A23L 33/00; B65D 75/00; B65D 25/04

(52) U.S. Cl. CPC A23P 10/22; A23L 33/12; A23L 33/24; A23L 33/15; A23L 33/16; A23L 33/19; A23V 2002/00; A23L 7/126; A23P 20/11; A23L 33/40; B65D 75/002; B65D 25/04; A23L 33/185

(57) ABSTRACT

The invention provides a kit comprising a satiety inducing component A, useful for the treatment and/or prevention of obesity; and a component B complementing component A. Component A comprises a first ingestible solid formulation of a lipid material and a water-swellable or water-soluble polymer, said first ingestible solid formulation being provided in form of ingestible particles that may be used as a partial or full meal replacement. Component B complements component A in that it provides e.g. specific nutrients such as unsaturated fatty acids, vitamins, proteins, amino acids, micro-nutrients, dietary elements, dietary fibres or combinations thereof to a human subject in order to reduce the risk of any deficiencies thereof during a dieting schedule. These nutrients in component B may be provided in an oil, a granulate and/or a powder or powder blend. Alternatively, component B may comprise a second ingestible solid formulation similar to the first ingestible solid formulation, which may be provided in form of ingestible particles, but also in other forms than component A, e.g. as snack-bars.

### FIELD

The present invention relates to kits of pharmaceutical or food compositions for oral consumption which are capable of inducing a long lasting satiety effect and thus useful in the prevention or treatment of obesity, or for the control or reduction of appetite, or the induction and/or prolongation of satiety.

### BACKGROUND

In the field of dietary regimes and/or dietary formulations, various approaches have been chosen to induce satiety in a subject and/or to prolong satiety. For instance, protein powders or protein compositions have been employed, relying on the known satiety inducing effects of proteins. Alternatively, swelling or expanding systems have been employed—commonly based on polymers—which stimulate e.g. pressure sensors in the gut and thereby simulate a filling sensation which reduces the appetite.

US 2003/161885 A1 for example describes systems based on hydrophilic polymers such as cellulose derivatives which induce a filling and thus satiating effect. The document further describes how addition of small amounts of fatty acids or fatty acid derivatives to the polymer (typically about 3-5% based on the polymer), increased the residence time of the swollen polymer in the gut, which in US 2003/161885 A1 was considered useful in prolonging the satiety inducing effect. However, US 2003/161885 A1 is silent on a satiety effect induced by the fatty acids or fatty acid derivatives themselves.

In general, there is only limited prior art on using lipid materials such as fatty acids or fatty acid derivatives for inducing and/or prolonging satiety and reducing appetite and employing this in body weight reduction and/or the treatment of obesity or conditions associated therewith. This may be attributed to the fact that lipids have a high caloric density and thus are typically not considered suitable as dietary formulations. It may further be attributed to scientific publications who list lipids as the least satiating macronutrients after proteins and carbohydrates (e.g. Hermsdorff H H; Arch Latinoam Nutr. 2007 March; 57(1):33-42.).

On the other hand, from recent research in the area of anti-obesity, it has emerged that triglycerides or their digestive degradation products, free fatty acids, may act as satiety inducing compounds. For instance, it is well documented that the infusion of lauric acid or oleic acid into the duodenum by means of a feeding tube provides for strong satiety signalling. Consequently, there is a need to provide sustained release of free fatty acids and/or release targeted to the duodenum; and further to provide compositions, dosage forms and methods of effectively employing lipids in the treatment of obesity or conditions associated therewith.

Apart from the induction and/or prolongation of satiety and reduction of appetite by a compound or composition as such, further, more compliance-related factors should also be addressed. Dieters—in particular when on their dietary schedule, or regimen, for a longer period of time (such as a week or several weeks)—may worry about their intake of nutrients, such as whether they get sufficient supply of vitamins or micro-nutrients in terms of dosing, or whether they get the right types of nutrients to facilitate their dietary schedule. Others may be concerned when suffering from e.g. food-related allergies and intolerances, diabetes, and the like. Alternatively, or in addition, some consumers may find it hard to stick to a dietary schedule when ‘on the go’ and/or in between meals, in particular when one or more meals are replaced fully or partially by a dieting composition. Any of these issues may limit consumer compliance and reduce effectiveness of the dietary schedule, or regimen; and should thus preferably be addressed.

It is an object of the present invention to provide an effective method for delivering fatty acids and lipids based on fatty acids to the gastrointestinal tract. A further object is to provide means for delivering such fatty acids and lipids to specific regions within the gastrointestinal tract, such as the stomach or the duodenum. A further object is to provide compositions, dosage forms and/or kits thereof which are useful for the oral delivery of fatty acids and lipids based on fatty acids. It is a further particular object of the present invention to improve the compliance of the consumer with a dietary schedule based on delivery of fatty acids and lipids based on fatty acids, to increase safety of consumers, especially with respect to meeting a consumer's dietary needs even during weight loss regimens; and/or to account for a consumer's dietary requirements with respect to food related allergies and intolerances, diabetes, and the like, e.g. by customisation. A yet further object is to provide a method for the treatment and/or prevention of obesity and diseases or conditions associated with obesity.

Further objects will become apparent on the basis of the following description including the examples, and the patent claims.

### SUMMARY OF THE INVENTION

In a first aspect, the invention provides a kit comprising a component A in combination with a component B, wherein component A comprises a first ingestible solid formulation comprising a first intimate mixture of a first lipid material comprising a medium or long chain fatty acid compound and a first water-swellable or water-soluble polymer, said first ingestible solid formulation being provided in form of ingestible particles having a sieve diameter in the range from 0.01 mm to 10 mm, or from 0.05 mm to 3 mm; and

wherein component B is selected from
an oil comprising an unsaturated fatty acid compound, a vitamin, or combinations thereof,
a powder, or powder-blend, comprising a protein, a vitamin, a micro-nutrient, a dietary element, a dietary fibre, an amino acid or combinations thereof,
a granulate comprising a protein, a vitamin, a micro-nutrient, a dietary element, a dietary fibre, an amino acid or combinations thereof,
a powder, powder-blend or granulate comprising a flavourant, and/or
a second ingestible solid formulation comprising an intimate mixture of a second lipid material comprising a medium or long chain fatty acid compound and a second water-swellable or water-soluble polymer, wherein the second ingestible solid formulation is different from the first ingestible solid formulation, and
   wherein the kit components A and B are supplied in:
separate compartments of one primary package,
separate primary packages packaged together within one secondary package,
separate primary packages packaged in two or more separate secondary packages which are in turn held together by paper or plastic wrappers, ribbons, sleeves or the like, or
combinations thereof.

Optionally, the kit may further contain written instructions, pictograms or other readable forms of instructions (e.g. barcodes, QR-codes) to the consumer concerning recommendations as to the manner of oral consumption of component A and/or component B; e.g. if and how one or all kit components should be mixed with either each other and/or with ingestible liquids or semisolids (e.g. water, milk, juice, yoghurt); or how many times a day one or all kit components should be consumed.

The ingestible particles in component A may be provided in the form of granules, pellets and/or minitablets having a sieve diameter in the range from 0.05 mm to 3 mm, and/or in the form of flakes, shavings, chips and/or sprinkles having a sieve diameter in the range from 0.01 mm to 10 mm, preferably 1 mm to 10 mm.

Similarly, the second ingestible solid formulation in component B may also be provided in the form of granules, pellets and/or minitablets having a sieve diameter in the range from 0.05 mm to 3 mm, and/or in the form of flakes, shavings, chips and/or sprinkles having a sieve diameter in the range from 0.01 mm to 10 mm. In addition, the second ingestible solid formulation in component B may further be provided in the form of a non-particulate matrix, such as in the form of a snack-bar comprising the second intimate mixture and optionally a further comestible material; or the second intimate mixture forming a layer on a further comestible material, such as cereal flakes, soy puffs or rice puffs.

Where the first ingestible solid formulation and/or the second ingestible solid formulation is provided in the form of granules, pellets and/or minitablets having a sieve diameter in the range from 0.05 mm to 3 mm, said granules, pellets and/or minitablets may exhibit different ‘designs’: they may comprise a) an active core comprising the first and/or second lipid material and the first and/or second water-swellable or water-soluble polymer in the form of the first and/or second intimate mixture, or they may comprise b) an inert starter core, such as non-pareils, which is coated with an active coating of the first and/or second intimate mixture comprising the first and/or second lipid material and the first and/or second water-swellable or water-soluble polymer. Optionally, both these designs may further comprise a top-coating comprising a third lipid material, wherein said top-coating may be substantially free of the first and/or second water-swellable or water-soluble polymer, and wherein the third lipid material may be the same as, or different from, the first and/or second lipid material.

In one embodiment, the first and/or second lipid material comprises a medium or long chain fatty acid compound exhibiting a melting point higher than 37° C., or from 38° C. to 75° C., or from 40° C. to 70° C.; and the first and/or second water-swellable or water-soluble polymer is selected from cellulose ethers, pectins, alginic acid, poly(acrylic acid), poly(methacrylic acid), copolymers of acrylic and methacrylic acid, poly(hydroxyethyl methacrylic acid), chitosan, gellan gum, guar gum, xanthan gum and gum arabic, or respective salts thereof; or from water-soluble polysaccharides based on glucose or fructose having an average degree of polymerisation from 2 to 100, or from 4 to 80 and being resistant to digestion in the human small intestine.

Preferably, each of the first and the second ingestible solid formulation comprise at least 40%, or at least 45%, or at least 50% of the first or second lipid material, respectively; and at least 10%, or at least 20%, or at least 30% of the first or second water-swellable or water-soluble polymer, respectively.; and/or further preferably each of the first and the second intimate mixture comprise at least 40%, or at least 45%, or at least 50% of the first or second lipid material, respectively; and at least 10%, or at least 20%, or at least 30% of the first or second water-swellable or water-soluble polymer, respectively.

In one embodiment, the first lipid material in the first intimate mixture comprises a triglyceride, a blend of partial fatty acid glycerides, and/or a blend of a triglyceride with a partial fatty acid glyceride, and the first water-swellable or water-soluble polymer in the first intimate mixture comprises a cellulose ether, an alginate, a pectin and/or a xanthan. For instance, the first lipid material in the first intimate mixture may comprise a blend of glycerol monolaurate (GML) and glycerol monooleate (GMO), or a blend of glycerol monostearate (GMS) and glycerol monooleate (GMO), in an intimate mixture with a cellulose ether selected from hydroxyethyl cellulose (HEC), hydroxypropyl cellulose (HPC), hydroxypropyl methylcellulose (HPMC), methylcellulose (MC), and carboxymethylcellulose (CMC); preferably hydroxypropyl methylcellulose.

Optionally, component A may further comprise a powder, powder blend or granulate comprising a protein and/or a thickening agent, in addition to the first ingestible solid formulation.

In one embodiment, the second lipid material comprises a triglyceride; the second water swellable or water-soluble polymer is selected from a dextrin having a degree of polymerisation from 4 to 40, or from 10 to 30, preferably from 12 to 25; or an inulin having a degree of polymerisation from 4 to 60, or from 5 to 25; and the second ingestible solid formulation contains not more than 5% mucoadhesive polymer. In a specific embodiment, the second lipid material may, for instance, comprise a fractionated but non-hydrogenated palm stearin or palm kernel stearin, and the dextrin is a resistant dextrin derived from wheat or maize starch.

Optionally, the first and/or second ingestible solid formulation may further comprise a salt of a medium or long chain fatty acid, e.g. a sodium salt or potassium salt or calcium salt of stearic acid.

Further optionally, the first and/or second ingestible solid formulation may comprise a sugar, a sugar alcohol, an amino acid, a protein, a vitamin, micro-nutrient and/or a further dietary element incorporated in the first and/or second intimate mixture, respectively.

For the kits according to the invention, the protein may be an isolate and/or concentrate of a milk protein, a whey protein, a soy protein, a pea protein, a brown rice protein and/or a wheat protein;

the thickening agent may be selected from carbomers, agar, gelatine, pectin, carrageenan, alginic acid derivatives, locust bean gum, xanthan gum, tragacanth, chitosan, pullulan, curdlan, psyllium seed husks, wheat-derived dextrins and cellulose derivatives, preferably from carboxymethylcellulose (CMC), in particular sodium-CMC, xanthan gum or guar gum;
the oil may be selected from omega-6 oils such as safflower seed oil, sunflower oil, grape seed oil, wheat germ oil, pumpkin seed oil, evening primrose oil, soy-bean oil, walnut oil or corn oil; from omega-3 oils such as linseed oil (or flaxseed oil), rape seed oil, hemp seed oil, clary sage seed oil, algae oil, Sacha Inchi oil, Echium oil, fish oil, squid oil or krill oil; or combinations thereof;
the amino acid may be selected from
a) L-amino acids;
b) the group consisting of L-isoleucine, L-valine, L-tyrosine, L-methionine, L-lysine, L-arginine, L-cysteine, L-phenylalanine, L-glutamate, L-glutamine, L-leucine, and L-tryptophan;
c) the group consisting of L-phenylalanine, L-leucine, L-glutamine, L-glutamate, and L-tryptophan; or
d) L-tryptophan;
   the sugar or sugar alcohol is selected from mono-or disaccharides including sucrose, fructose and glucose, and polyhydric alcohols including arabitol, erythritol, glycerol, isomalt, lactitol, maltitol, mannitol, sorbitol or xylitol;
   the medium or long chain fatty acid salt is selected from the salts of capric acid, lauric acid, myristic acid, palmitic acid, stearic acid, arachidic acid, myristoleic acid, palmitoleic acid, sapienic acid, oleic acid, linoleic acid, linolenic acid and eicosapentaenoic acid, preferably a sodium salt or potassium salt or calcium salt of stearic acid, arachidic acid or oleic acid;
   the vitamin may be selected from retinol, retinal, beta carotene, thiamine, cyanocobalamine, hydroxycyanocobalamine, methylcobalamine, riboflavin, niacin, niacinamide, pantothenic acid, pyridoxine, pyridoxamine, pyridoxal, biotin, folic acid, folinic acid, ascorbic acid, cholecalciferol, ergocalciferol, tocopherol, tocotrienol, phylloquinone, and menaquinone;
   the micro-nutrient may be selected from organic acids, such as acetic acid, citric acid, lactic acid, malic acid, or taurine; and trace -or micro-minerals such as salts of boron, bromine, cobalt, chromium, copper, fluoride, iodine, iron, manganese, molybdenum, selenium, or zinc (optionally present in ionised or complexed form or as a salt, an oxide or a chelated salt); choline and cholesterol;
   the dietary element may be a macro-mineral selected from calcium, chlorine, magnesium, phosphorous, potassium, sodium and sulphur (optionally in ionised or complexed form or as a salt, an oxide or a chelated salt); and/or
   the dietary fibre is selected from a prebiotic or natural gum, cellulose, lichenin, chitin, hemicellulose, or lignin.

Optionally, the oil may be provided in a powdered form, as a so-called fat-powder or oil-powder; e.g. a carrier of tapioca-maltodextrin ‘loaded’ with 65-67% of the oil.

Other optional components or constituents may be present in the composition, such as a sweetening agent, a flavouring agent, a colouring agent, a stabilising agent, a wetting agent, a bulking agent, a suspending agent, a pH-modifying agent, and/or a flow-regulating agent.

Component A may be provided in a multiple-dose container, optionally equipped with a dosing tool, or in one or more single dose units, or single dose packages; and component B may be provided in one or more single dose units, or single dose packages, said single dose unit, or single dose package being selected from vials, ampoules, bottles, sachets, stickpacks, foil or plastic bags, or filled straws, or their respective compartments. In one embodiment, component A may be provided in a first vial, ampoule or bottle; preferably one that is equipped with a cap housing a reservoir which is separated from, and optionally connectable, to the inner volume of said first vial, ampoule or bottle; and component B may be provided in said cap reservoir, or in a sachet, stickpack, foil or plastic bags, or filled straw, or in a second vial, ampoule or bottle.

In a further aspect, a single dose unit, or single dose package, of component A weighs from about 3 g to about 80 g, or from about 3 g to about 60 g, or from about 3 g to about 40 g, or from about 3 g to about 20 g and comprises at least about 2 g of the first lipid material, preferably at least about 3 g of the first lipid material.

In a yet further aspect, the invention provides the use of the kit for the prevention and/or treatment of obesity, or a disease or condition associated with obesity (such as hyperlipidemia, diabetes, or heart disease). Moreover, the use in appetite suppression and induction and/or prolongation of satiety as well as in body weight reduction is provided. The use may be associated with a dietary schedule according to which at least component A is administered to a human subject at a frequency of at least once a day over a period of at least one week, and wherein optionally the oral administration of at least component A may be used as full or partial meal replacement. Component B is mainly aimed at improving consumer compliance with the dietary schedule, e.g. by supplementing nutrients which the consumer may lack, or may fear to lack, during dieting, and in particular providing the right amounts of nutrients per defined time period during this diet (such as per day or per week), by providing healthier ‘snacking’ options to the consumer for times in between meals or while being ‘on the go’,; and/or by simply providing one or more flavourants which the user can choose ad libitum and add to component A prior to consumption. Any instructions relating to said dietary schedule may be provided to a human subject in writing or other readable forms (e.g. barcodes, QR-codes), and may optionally be part of the kit.

### Definitions

The term “a” as used herein means “at least one” unless specified otherwise; i.e. it does not exclude pluralities. In other words, all references to singular characteristics or limitations of the present disclosure shall include the corresponding plural characteristic or limitation, and vice versa, unless explicitly specified otherwise or clearly implied to the contrary by the context in which the reference is made.

Unless the context clearly indicates or requires otherwise, the terms ‘comprising’, and ‘containing’ and similar expressions are to be construed in an open and inclusive sense, as in ‘including, but not limited to’ in this description and in the claims. Yet, at the very least the respective expressions disclose those embodiments in which, for instance, the described product consists of the specifically listed parts, or components. For instance, as used herein expressions like ‘A kit comprising the components A and B . . . ’ or ‘An intimate mixture comprising a lipid material and a water-swellable or water-soluble polymer . . . ’, are at least to be understood as ‘A kit consisting of the components A and B . . . ’ or ‘An intimate mixture consisting of a lipid material and a water-swellable or water-soluble polymer . . . ’, respectively; even though the latter embodiment may not always be disclosed verbatim for reasons of simplicity.

All percentages, parts and ratios as used herein, are by weight of the respective total weight, unless otherwise specified.

A ‘medium chain fatty acid’, as used herein, is understood as a fatty acid with an acyl residue of 6 to 12 carbon atoms, whereas a ‘long chain fatty acid’ means a fatty acid with an acyl chain of 13 to 21 carbon atoms.

The term ‘fatty acid compound’, as used herein, may refer to a free fatty acid, salts of a fatty acid, such as a sodium, potassium or calcium salt; or an esterified fatty acid, such as a mono-, di- or triglycerides. Preferably, when used in referral to the term ‘lipid material’ (e.g. first and/or second lipid material), the term ‘fatty acid compounds’ may be construed a bit more limited, and refers to free fatty acids, or esterified fatty acids, such as a mono-, di- or triglycerides. In the case of di- and triglycerides, these may have different fatty acid residues per glyceride molecule. Further, the acyl chain of the fatty acid may be saturated or unsaturated.

The melting point, as used herein, refers to e.g. a fatty acid glyceride compound as such, i.e. not in its hydrated state, and it should be understood as the temperature at which the glyceride component melts entirely, without solid residue, at normal pressure. If a glyceride compound, in particular a fatty acid glyceride compound, exhibits a melting range (rather than a melting point) the melting point is understood as the higher limit of the range. Where the first and/or second lipid material comprises blends of fatty acid glyceride compounds (e.g. more than one fatty acid glyceride, or a fatty acid glyceride in a blend with a free fatty acid), then at least the fatty acid glyceride compound and/or at least one of the fatty acid glyceride compounds has a melting point or melting range of higher than 37° C.

As used herein, a ‘water-swellable or water-soluble polymer’ is a hydrophilic or amphiphilic polymeric material capable of dissolving or swelling by water, or in an aqueous environment. The polymer is considered ‘water-soluble’ if it exhibits a solubility in water of at least 1 mg/L in purified water at 25° C. The term ‘swelling’ typically refers to the volume increase of a solid body caused by an influx, or diffusion process of water accompanied by hydration, i.e. wetting and absorption of moisture. However, swelling as such does not necessarily render a water-swellable or water-soluble polymer mucoadhesive.

Any sieve diameter provisions such as in the range from e.g. 0.01 mm to 10 mm herein have the meaning that a particle of said sieve diameter would normally pass through a sieve having an aperture, or opening size, of 10 mm, but not pass through a sieve having an aperture, or opening size, of 0.01 mm or less. Within a formulation comprising a plurality of particles, these particle sizes should be interpreted to characterise the preferred mass median sieve diameters of particles.

The terms ‘mucoadhesive’ or ‘mucoadhesiveness’ refer to the capability of a compound or material to adhere to a mucosa, or mucosal membrane. To determine mucoadhesiveness in the context of the invention, it is preferred that a modified falling liquid film method (described among other method in Mucoadhesive drug delivery systems, Carvalho F. C. et al., Brazilian Journal of Pharmaceutical Sciences 46 (2010)) is employed. According to the method, the selected mucous membrane (e.g. from pig stomach) is placed in a petri dish together with simulated gastric fluid at a controlled temperature of 37° C. The petri dish is placed on a table undergoing a tilting movement. Both tilting movement and volume of buffer are selected so that small waves of buffer continuously run over the surface of the mucous tissue. In the falling liquid film method, a similar agitation is achieved by pumping buffer over mucosal tissue tilted at a 45° angle. The amount of particles remaining on the mucous membrane after a specified time interval can be quantified by various methods. For instance, particles can be counted, optionally using a magnifying glass or microscope, or they may be collected, dried and measured gravimetrically.

Unless specified otherwise, the terms ‘the mixture’ or ‘the intimate mixture’ as used herein refer to the mixture according to the invention; i.e. intimately mixed blends of lipid material(s) and water-swellable or water-soluble polymer(s), and where applicable further optional components of the ingestible particles, such as medium or long chain fatty acid salts, sugars, sugar alcohols, vitamins, amino acids, proteins, micro-nutrients and/or further dietary elements. This means that one material (usually, and preferably, the water-swellable or water-soluble polymer in the present invention) may be largely dispersed within the other material (usually, and preferably, the lipid material invention), whether molecularly, colloidally or in the form of a solid suspension; i.e. the polymer and the lipid are blended into one coherent, physically inseparable ingestible solid formulation, or material, wherein it is irrespective how this coherence and/or inseparability are achieved.

In other words, the lipid material may form a continuous phase in which the water-swellable or water-soluble polymer is discontinuous and in dispersed form. Yet, for the avoidance of doubt, this does not exclude that some of the polymeric material is not fully dispersed, or enrobed, in the lipid material's continuous phase, but positioned at its outer surface; this can never be excluded with certainty for any manufacturing processes in which the water-swellable or water-soluble polymer is added to, and dispersed in, the lipid material. Alternatively—and depending on the specific ratio of the materials to each other, as well as the method of forming the intimate mixture—both materials, lipid and polymer, may be dispersed by/in each other with no clear distinction between continuous and discontinuous phase.

The main requirement of an ‘intimate mixture’ as used herein is that the mixture is relatively homogenous and physically inseparable, e.g. with the ratio between the first and/or second lipid material(s) and the first and/or second water-swellable or water-soluble polymer(s) being approximately constant at any given position within the intimate mixture. Examples of intimate mixtures according to the invention include but are not limited to melts of the lipid material(s) into which the water-swellable or water-soluble polymer(s) is/are mixed prior to cooling down, as well as any co-processed mixture in which one compound, usually, and preferably, the water-swellable or water-soluble polymer is embedded in and/or coated with the other, usually, and preferably, the lipid material. These systems are probably best described as solid dispersions, or solid suspensions and represent a form of ‘matrix systems’; as opposed to so-called ‘reservoir systems’ (optionally in the form of ‘micro-beads’/‘micro-capsules’), where one material encapsulates the other and/or where one material is substantially found in some sort of coating while the other is substantially found within the coated core. Hence, examples of what is not considered an ‘intimate mixture’ according to the invention include i) mere uncompressed powder blends of the two compounds, because such powder blends may in theory be physically separated and thereby lose their homogeneity (e.g. one compound being wetted by an ingestible liquid, while the other is poorly wetted and may exhibit floatation); or ii) encapsulated systems as they are common, for instance, with coacervation processes, e.g. a core of the lipid material surface-coated with a coherent layer of the polymer (or vice versa) rather than being dispersed and embedded in it.

As used herein, an ingestible particle is a particle which is in principle suitable for oral ingestion, or oral administration. A particle which by virtue of its composition, size and morphology would be suitable as a food component or a component of a pharmaceutical composition for oral use is an example of an ingestible particle.

A ‘flavourant’, or flavouring agent, as used herein refers to a compound and/or blend of compounds which provide a pleasant taste, including:
sugars (e.g. mono-or disaccharides such as sucrose, fructose or glucose);
sugar alcohols (e.g. mannitol, sorbitol, xylitol, maltitol, arabitol, erythritol, glycerol, isomalt, lactitol);
natural or artificial sweeteners (e.g. aspartame, cyclamate, saccharin, stevia glycosides, sucralose, or acesulfame potassium);
natural and artificial flavours (also referred to as ‘aroma’; e.g. flavours selected from dried fruit juice or herbal extracts and/or artificial flavours such as honey-, orange-, lemon-, cherry-, tropical fruit-, grapes-, berries-, banana-, contramarum-, or peach aroma, or mixtures thereof); or combinations thereof.
   Artificial sweeteners and flavours may be nature identical The main purpose of the flavourant or flavourant combination as used herein is to provide a pleasant taste, e.g. by mixing a component B comprising the one or more flavourants with component A and an ingestible liquid or semisolid such as water, milk, juice, yoghurt etc..

### DETAILED DESCRIPTION OF THE INVENTION

In a first aspect, the invention provides a kit comprising a component A in combination with a component B. Component A comprises a first ingestible solid formulation comprising a first intimate mixture of a first lipid material comprising a medium or long chain fatty acid compound and a first water-swellable or water-soluble polymer, wherein the first ingestible solid formulation is provided in form of ingestible particles having a sieve diameter in the range from 0.01 mm to 10 mm, or from 0.05 mm to 3 mm. Component B is selected from
an oil comprising an unsaturated fatty acid compound, a vitamin, or combinations thereof,
a powder, or powder-blend, comprising a protein, a vitamin, a micro-nutrient, a dietary element, a dietary fibre, an amino acid or combinations thereof,
a granulate comprising a protein, a vitamin, a micro-nutrient, a dietary element, a dietary fibre, an amino acid or combinations thereof,
a powder, powder-blend or granulate comprising a flavourant, and/or
a second ingestible solid formulation comprising a second intimate mixture of a second lipid material comprising a medium or long chain fatty acid compound and a second water-swellable or water-soluble polymer, wherein the second ingestible solid formulation is different from the first ingestible solid formulation; and
   wherein kit components A and B are supplied in:
separate compartments of one primary package,
separate primary packages packaged together within one secondary package,
separate primary packages packaged in two or more separate secondary packages which are in turn held together by paper or plastic wrappers, ribbons, sleeves or the like, or
combinations thereof.

For reasons of simplification, the ‘lipid material comprising a medium or long chain fatty acid compound’ will herein commonly be referred to shortly as ‘the lipid material’. The first and second lipid material may be the same or different. In other words, all provisions on ‘the lipid material’ are thus intended to apply to both materials; only where specific provisions are aimed at one of the two in particular, this will be indicated by referring in more detail to ‘the first lipid material’ and ‘the second lipid material’. Same applies in analogy to the first and second water-swellable or water-soluble polymer.

Optionally the first and/or second ingestible solid formulation further comprises a medium or long chain fatty acid salt, e.g. a sodium salt or potassium salt or calcium salt of stearic acid. Further optionally the first and/or second ingestible solid formulation comprises a sugar, a sugar alcohol, an amino acid, a protein, a vitamin, a micro-nutrient and/or a further dietary element incorporated in the first and/or second intimate mixture, respectively. Alternatively, these optional components may be comprised in the first and/or second ingestible solid formulations, but incorporated in the optional top-coating instead, as will be detailed further below.

For the avoidance of doubt, it should be understood that the presence of the medium or long chain fatty acid salt, sugar, the sugar alcohol, the amino acid, the protein, the vitamin, the micronutrient and/or the further dietary element in the first and/or second ingestible solid formulation (and/or mixtures for the preparation of said formulations) is optional in all embodiments, unless where explicitly stated otherwise. This means that, as used herein, any listings including any of these optional components simply refer to the specific embodiments in which one or more of them are present, while not excluding those embodiments without these optional components. And unless where specified otherwise, the optional components such as amino acids, vitamins and/or micro-nutrients which are incorporated into the intimate mixture(s) and/or the optional top-coating do not differ in nature from those which are not incorporated into the intimate mixture, but instead may be added or combined differently (e.g. as an extra-granular powder in addition to a granular intimate mixture). In other words, the medium or long chain fatty acid salts, sugars, sugar alcohols, vitamins, amino acids, proteins, micro-nutrients or further dietary elements in the intimate mixture of component A and/or B may be selected from the same group as those which are, for instance, provided as a separate powder or granulate component B. Further details on medium or long chain fatty acid salts, sugars, sugar alcohols, vitamins, amino acids, micro-nutrients, dietary elements, proteins or dietary fibres will be provided further below.

The inventors have found that the ingestible solid formulations as defined herein, and in particular the intimate mixtures comprised therein, are capable of effectively inducing and/or prolonging satiety and suppressing the appetite; and thereby may be used to prevent or treat obesity or conditions associated with obesity; e.g. by using the ingestible solid formulations as defined herein for body weight reduction.

The inventors have further found that the kit (i.e. the combination of the ingestible solid formulation in component A with a further component B) is capable of improving the consumer's compliance with a dietary schedule. This is achieved, for instance, by supplementing nutrients which the consumer may lack, or fear to lack, during the diet (such as vitamins, minerals, proteins etc.) with component B. Providing such nutrients in the right amounts per defined time period (e.g. per day or per week) in this kit form reduces consumer worries and facilitates the dieting routine, for instance, in that the consumer does not need to think about the correct dosing of component A and further nutrients anymore. The compliance is further improved by providing healthier ‘snacking’ options to the consumers for times in between meals, or while being ‘on the go’, and/or by simply providing one or more flavourants which the user can choose ad libitum and add to component A prior to consumption.

Unlike in the prior art—where hydrophilic polymer systems are employed to induce satiety by swelling and induction of a ‘filling effect’—it is believed by the authors that the above-described satiety effect of the invention is achieved by fatty acid administration, preferably to the lower intestines.

Without wishing to be bound by theory, it is currently believed that upon oral administration, the fatty acid or fatty acid ester comprised in the ingestible solid formulations is more effectively delivered to the mucosa of the gastrointestinal tract, such as the stomach or duodenum, by virtue of the water-swellable or water-soluble polymer, which may be instrumental in providing a prolonged or otherwise increased interaction of the fatty acid material with target structures in the mucosa. Furthermore, the water-swellable or water-soluble polymer may be instrumental in providing a prolonged or otherwise increased interaction of the optionally added medium or long chain fatty acid salt, amino acid, the protein, the vitamin, the micro-nutrient and/or the further dietary element (if present in the intimate lipid/polymer-mixture) with target structures in the mucosa.

It was found in in vitro tests, that the water-swellable or water-soluble polymer prolongs the integrity of the ingestible solid formulation (or particles thereof) after ingestion as compared to the lipid material as such, i.e. without the water swellable or water-soluble polymer. This prolonged integrity of the lipid-containing solid formulations—and in particular particles prepared from it and/or particles obtained during chewing—is currently believed to result in more rapid gastric emptying of said particles and therefore more rapid interaction of any fatty acids or fatty acid esters already released from the particles with the intestinal mucosa; similar to the more rapid gastric emptying observed for pellet formulations which may even pass the closed pylorus. It is further postulated, that the prolonged integrity of the lipid-containing particles also results in a delayed and/or extended delivery of the remaining fatty acids or fatty-acid esters, which thus reach the more distal parts of the small intestine such as the jejunum or ileum. This is thought to be instrumental in the prolonged, lasting satiety effect.

The inventors have found that the satiety-inducing effect of a free or esterified fatty acid is enhanced if it is delivered in the form of the ingestible intimate mixtures of the invention, as comprised in kit components A and B of the kit. This allows e.g. appetite suppression, body weight reduction as well as the prevention and/or treatment of obesity even without pharmacological intervention using a synthetic drug. It is therefore a preferred embodiment, that the kit, its components A and B, and in particular the ingestible solid formulations and the ingestible intimate mixtures comprised therein are free of a synthetic drug substance. In particular, the kits and none of its components comprise drugs with a pharmacologic effect on satiety, appetite or body weight, such as sibutramin, cathin or lipase inhibitors like.

In other words, the first and/or second ingestible formulations comprised in kit components A and B may essentially consist of
the first and/or second lipid material,
the first and/or second water-swellable or water-soluble polymer;
the optional components selected from medium or long chain fatty acid salts, sugars, sugar alcohols, vitamins, amino acids, proteins, micro-nutrients and/or further dietary elements; and
further optionally—depending on the ‘design’ of the ingestible formulations, or the particles comprised therein—an inert starter core (such as non-pareils) and/or a third lipid material in the form of top-coating, which optionally may further contain a hydrophilic compound such as a hydrophilic polymer as a disintegration enhancer.

In order to enhance the beneficial effects of the ingestible particles on e.g. satiety—and more specifically of the first and/or second intimate mixtures—it is preferred that the weight ratio of the first and/or second lipid material to the water-swellable or water-soluble polymer (or in other words m_{lipid}/m_{polymer}) is in the range from about 0.1 to about 10. In some embodiments, the weight ratio is from about 0.1 to about 5, from about 0.1 to about 3, from about 0.1 to about 2, or from about 0.1 to about 1. In further embodiments, this weight ratio is from about 0.2 to about 1.5, from about 0.25 to about 1.2, from about 0.25 to about 1.0, such as about 0.3, about 0.5., about 0.75, or about 1, respectively. Particularly preferred is a weight ratio from about 0.5 to about 5, or from about 0.75 to about 4, or from about 1 to about 3, respectively; e.g. 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3.0.

Furthermore, it is considered possible that the water-swellable or water-soluble polymer increases the digestibility of lipid materials of otherwise limited digestibility such as a hard fat such as for instance tristearin. In a rat feeding study, tristearin (Dynasan® 118, melting range 72-75° C.) was found to provide an energy content of only 3 kcal/g, corresponding to a true digestibility of stearic acid from tristearin of only 0.15 g/g independent from intake (Ranhotra, et al., J. Food Sci. 63 (1998) 363-5). Possibly, the incorporation of a water-swellable or water-soluble polymer enhances the lipid particles' surface wetting properties and/or facilitates water and bile acid access and subsequent emulsification and lipase-mediated hydrolysis of the lipid, such that satiety inducing fatty acids are gradually released in the intestines even for those poorly digestible lipids.

For some of the water-swellable or water-soluble polymers, addition of such polymers provides the ingestible solid formulation (or particles thereof) with mucoadhesive properties, in particular in combination with a prolonged integrity of the particle.

It is preferred for the satiety effect that each of the first and the second ingestible solid formulation comprises at least 40%, or at least 45%, or at least 50% of the first or second lipid material, respectively, and at least 10%, or at least 20%, or at least 30% of the first or second water-swellable or water-soluble polymer, respectively. Further preferably, each of the first and the second intimate mixture comprises at least 40%, or at least 45%, or at least 50% of the first or second lipid material, respectively, and at least 10%, or at least 20%, or at least 30% of the first or second water-swellable or water-soluble polymer, respectively. Further preferably, each of the first and the second ingestible solid formulation comprises at least 55%, or at least 60%, or at least 65% or at least 70% of the first or second lipid material. Alternatively, or in addition, each of the first and the second intimate mixture comprises at least 55%, or at least 60%, or at least 65% or at least 70% of the first or second lipid material.

Both, the first and the second ingestible solid formulation may either comprise their respective first and second intimate mixture of lipid material and water-swellable or water-soluble polymer (and optionally further components such as medium or long chain fatty acid salts, sugars, sugar alcohols, vitamins, amino acids, proteins, micro-nutrients and/or further dietary elements); or these formulations may be consisting of said respective mixtures. In the latter case, the terms ‘ingestible solid formulation’ and ‘intimate mixture’ would refer to the same thing, or product.

Illustrative examples of ingestible solid formulations comprising the intimate mixture include: a granule, such as an extrudate, formed from the intimate mixture and coated with a top-coat of different composition; or a pellet where the intimate mixture is applied onto an inert starter core, such as a non-pareils; or small pieces of comestible materials, such as cereal flakes, onto which the intimate mixture is applied; etc..
Illustrative examples of ingestible solid formulations consisting of the intimate mixture include all forms in which the intimate mixture is neither coated onto, nor mixed with something else; e.g. extrudates of the intimate mixture; minitablets compressed from the intimate mixture; flakes cut from a cast and solidified sheet of the intimate mixture, etc..

In one embodiment, the first ingestible solid formulation may be provided in form of ingestible particles having a sieve diameter in the range from 0.01 mm to 10 mm, or from 0.05 mm to 3 mm, as mentioned above. In a more specific embodiment, the ingestible particles in component A are provided in the form of granules, pellets and/or minitablets having a sieve diameter in the range from 0.05 mm to 3 mm, and/or flakes, shavings, chips and/or sprinkles having a sieve diameter in the range from 0.01 mm to 10 mm, preferably 1 mm to 10 mm.

Similar to component A, the second ingestible solid formulation in component B may also be provided in the form of granules, pellets and/or minitablets having a sieve diameter in the range from 0.05 mm to 3 mm; or in the form of flakes, shavings, chips and/or sprinkles having a sieve diameter in the range from 0.01 mm to 10 mm.

The granules, pellets and/or minitablets may have a diameter in the range from about 0.05 mm to about 3 mm, or from about 0.1 mm to about 2.5 mm, or from about 0.1 mm to about 2 mm, such as about 0.25±0.20 mm, about 0.5±0.25 mm, about 1.0±0.25 mm, about 1.5±0.25 mm, about 2.0±0.25 mm, about 2.5±0.25 mm, about 3.0±0.25 mm respectively.

The flakes, shavings, chips and/or sprinkles may have a diameter in the range from about 0.5 mm to about 10 mm, or from about 0.6 mm to about 8 mm, or from about 0.65 mm to about 7 mm, or from about 0.7 mm to about 5 mm or from about 0.75 mm to about 2.5 mm, or from about 1 mm to about 2 mm. Flakes, shavings, chips and/or sprinkles have a far less compact, spheroidal or cuboidal shape in comparison to the granules, pellets and/or minitablets. Thus, the standard deviations of the mass median sieve diameters are typically more pronounced as may be easily understood when considering for instance a multitude of cylindrically shaped extruded sprinkles of about 0.9 mm diameter and up to about 2.5 mm length; in upright position a sprinkle may be able to pass a 1.0 mm sieve opening, while it would not be able to pass when lying in parallel with the sieve.

Examples of the above mentioned ingestible particles and in particular their various forms have already been described in more detail in previous applications PCT/EP2015/068501 or EP15202552.4, which are incorporated herein by reference, and briefly summarised below.

A granule refers to an agglomerated particle which has been prepared from a plurality of smaller primary particles, for instance using dry, wet or melt granulation techniques. The granule's final shape will be guided by the specific method of preparation. Extrudates are an example of granules.

A pellet, as used herein, is understood as a particle with a relatively spherical or spheroidal shape. If prepared by an agglomeration process, a pellet is a special type of a granule; however, pellets may also be prepared by other processes. In the context of the invention, the sphericity of a pellet is in the typical range of pellets used in pharmaceutical formulations for oral use, which often have an aspect ratio of longest space diagonal divided by shortest space diagonal in the range of about 1 to 1.5.

A minitablet, sometimes referred to as a microtablet, is a unit formed by compression or compaction of a powder or of granules; typically on tablet presses using punches.

A flake as used herein is understood as a flat, approximately platelet-like shaped piece of solid material (e.g. the intimate mixture of the invention) commonly exhibiting an aspect ratio of longest space diagonal divided by shortest space diagonal larger than 2.5; e.g. 3, 4, 5 or larger. In cases where their preparation involves a casting step, the flakes are commonly flat rectangles in cross-section, exhibiting approximately uniform thickness in the range of about 1 mm to 5 mm, while in top view the flakes may have various shapes ranging from triangular, rectangular to polygonal; depending e.g. on whether the larger cast sheet of the material is broken into flakes or cut (e.g. cut manually or by means of a rotating knife). Flakes may e.g. be rectangles or squares with a side length of about 2 mm to about 10 mm, or about 4 mm to about 8 mm; or about 5 mm to about 7 mm; and a thickness of about 0.01 mm to about 5 mm, preferably about 1 mm to about 5 mm, or about 1.5 mm to about 4 mm.

Shavings as used herein refers to thin, irregular shaped pieces of solid material (e.g. the intimate mixture of the invention) which are obtained from a larger block of said material by scraping, grating or shaving, e.g. using a wire, blade, or plough. Shavings are usually less regularly shaped and thinner than flakes, and thus may fold, roll or curve when removing them from the larger block.

Chips as used herein refers to pieces of solid material (e.g. the intimate mixture of the invention) commonly exhibiting an aspect ratio of longest space diagonal divided by shortest space diagonal larger than 2.5 which may e.g. be prepared by casting defined portions of the softened or semi-solid material from a nozzle onto a surface, and allowing said portions to solidify; thus leading to chips which are spherical or spheroidal in top view and curved, or half-elliptical or half-spherical, in cross-section. Examples of such shapes may be found in the confectionery field where chocolate raw masses are available as so-called Callets®. Also various suppliers of solid lipids deliver raw materials in chips.

Sprinkles as used herein are small cylindrical, or rod-shaped pieces of solid material (e.g. the intimate mixture of the invention) commonly exhibiting an aspect ratio of longest space diagonal divided by shortest space diagonal larger than 2.5; e.g. 3, 4, 5 or larger as observed for instance with cylinders having a diameter of about 1 mm to about 3 mm and a length of about 4 mm to about 10 mm. Similar or equal shapes are known e.g. from the g. sugary sprinkles common in the confectionery field.

In some cases, specific particulate forms of the first and/or second ingestible solid formulation may be preferred over others. For instance, granules, pellets and minitablets may exhibit better flow properties and/or better dispersibility than flakes, due to their typically rather regular and compact spheroidal or cuboidal shape. This may be desirable; e.g. when it is intended to disperse the ingestible solid formulation in a liquid. Flakes or chips on the other hand may be more suited when an ingestible solid formulation is intended to be ‘snacked’ as is by a human subject, either right out of its packaging or after being poured into a cupped hand. In that case, freely flowing pellets may cause too much spill and/or fall from a subject's hand.

While the majority of the particulate forms of the first and/or second ingestible solid formulation (granules, pellets, minitablets, flakes, shavings, chips and/or sprinkles) has a sieve diameter in the range from 0.01 mm to 10 mm, the ingestible particles may on rare occasions be slightly larger, such as from 0.01 mm to 15 mm, or 0.01 mm to 20 mm. These larger particles may for instance occur with the flakes, in particular when the flakes are not obtained by cutting a flat sheet of the intimate mixture into flakes but instead breaking it to pieces; and it does not per se deviate from the gist of the invention, since the larger particles are nonetheless exhibiting the same satiety inducing effect as found for the smaller particles. This may be due to observation that while for such larger particles of the ingestible solid formulation typically chewing by the consumer is required in order to form smaller, swallowable pieces; said chewed pieces behave similar in vivo as the smaller ingestible particles of the invention, such as the granules, pellets and/or minitablets.

When employing granules, pellets and/or minitablets, these may have different ‘designs’. According to the invention, the granules, pellets and/or minitablets comprise an active core comprising the first and/or second lipid material and the first and/or second water-swellable or water-soluble polymer in the form of the first and/or second intimate mixture; or an inert starter core coated with an active coating of the first and/or second intimate mixture comprising the first and/or second lipid material and the first and/or second water-swellable or water-soluble polymer.

Optionally the granules, pellets and/or minitablets comprise a top-coating comprising a third lipid material, wherein said top-coating is substantially free of the first and/or second water-swellable or water-soluble polymer, and wherein the third lipid material may be the same as, or different from, the first and/or second lipid material.

In other words, the granules, pellets and/or minitablets comprise the intimate mixture in the form of an active core, or in the form of an active coating on an inert starter core; both ‘designs’ optionally with a top-coating. For the embodiments comprising an inert core, a top-coating or both, it is preferred that the intimate mixture contributes at least about 50% to the weight of the total particle, or at least about 60%, or even at least about 70% of the total particle's weight.

Examples of such ingestible particles and in particular the above mentioned ‘designs’ of said particles and methods how to prepare them have already been described in more detail in previous applications, for instance in PCT/EP2015/068501 or in EP15175571.7, which are incorporated herein by reference, and briefly summarised below.

The intimate mixture comprising the lipid material and the water-swellable or water-soluble polymer may be prepared using any commonly known means available to a skilled person in the technical field which is capable of providing a homogenous and physically inseparable intimate mixture of at least said two materials. For instance, in one of the preferred embodiments, the lipid material may be molten at least partially, preferably completely, and blended with the water-swellable or water-soluble polymer—and, where applicable, further optional materials such as medium or long chain fatty acid salts, sugars, sugar alcohols, amino acids, proteins, vitamins, micro-nutrients and/or further dietary elements. Commonly, the water-swellable or water-soluble polymer and, where applicable, the further optional materials are added to the molten lipid material and blended in; however, the vice versa order (i.e. adding the molten lipid material to the polymer and further optional materials) is also acceptable. Alternatively, the materials may be co-processed with each other; e.g. using a screw extruder in which the materials are re-circulated until homogeneity of the mixture is obtained.

Of course, different processes may optionally be combined with each other whenever considered expedient, e.g. in order to improve homogeneity and/or increase the intimate mixture's density. For instance, a melt of a lipid material with water-swellable or water-soluble polymer blended into may be prepared as a premix, which is then solidified, shredded to smaller particles, and transferred to a screw extruder for further homogenisation of the mixture.

In one of the further preferred embodiments, the premix of the lipid material and the water-swellable or water-soluble polymer (and, where applicable, further optional materials such as medium or long chain fatty acid salts, sugars, sugar alcohols, amino acids, proteins, vitamins, micro-nutrients and/or further dietary elements); and optionally also the intimate mixture as such, is prepared without the addition and/or use of water or aqueous media; for instance, by using dry ice (CO₂) rather than regular ice (H₂O) for cooling down a molten premix rapidly, or by avoiding processes requiring larger amounts of water or aqueous media, such as spray-drying emulsions or coacervation. Without wishing to be bound by theory, it is currently believed that this provision ensures, or at least facilitates, a higher density of the resulting intimate mixture and the particles comprising it, or consisting of it, than obtained, for instance, for particles prepared by spray-drying an emulsion of the same components (as suggested e.g. for lipid-polymer-based tablet lubricants). Since there are no, or significantly less, lipid/water-interfaces occurring which could potentially reduce the contact between the (molten) lipid material and the water-swellable or water-soluble polymer, the mixing efficiency on a molecular level is improved. In consequence, increased and/or prolonged particle integrity may be achieved which, as described earlier, is considered beneficial for the prolonged, lasting satiety effect of the ingestible solid formulations.

It is currently believed, that the increased and/or prolonged particle integrity results in more rapid gastric emptying of said particles, and thus more rapid interaction of any fatty acids or fatty acid esters already released from the particles with the intestinal mucosa; as well as a delaying and/or extending the delivery of the remaining fatty acids or fatty-acid esters which thus reach the more distal parts of the small intestine such as the jejunum or ileum.

Once sufficient homogeneity is achieved, the intimate mixture is processed further to obtain ingestible particles of said intimate mixture in the desired sieve diameter range. Again, any commonly known means available to a skilled person in the technical field which is capable of providing ingestible particles of the desired sieve diameter may be employed. Exemplary means for this purpose include extrusion using a screw extruder (extruding the intimate mixture through a die), optionally equipped with a chopping blade (cutting the extruded strand into pieces, or particles, of desired length); spray congealing; melt granulation (e.g. in a fluidized-bed coater or a rotary coater); compression into minitablets (optionally after transferring the homogenous intimate mixture into a flowable powder, e.g. by grinding); melt injection into a liquid medium (optionally cooled); or applying the mixture onto inert cores, e.g. by (spray) coating in a fluidised bed coater or a rotary coater.

An inert core, as used herein, is a particle made from a physiologically acceptable material which itself does not substantially contribute to the physiological effect of the ingestible particles of the invention, i.e. the induction and/or prolongation of satiety. In one embodiment, the inert core is a spheroidal, preferably spherical, bead or non-pareils made from sugar (e.g. Suglets®), starch, cellulose, or microcrystalline cellulose (e.g. Cellets®), which is coated, preferably spray-coated, with the intimate mixture. Alternatively, the inert core is a crystal of appropriate size and shape, such as sugar (sucrose) crystal.

As mentioned above, in one embodiment of the invention, the granules, pellets and/or minitablets under a) and/or b)—i.e. those comprising an active core of the intimate mixture and those comprising an inert core coated with the intimate mixture, respectively—optionally comprise a top-coating comprising a third lipid material. This top-coating is substantially free of the first and/or second water-swellable or water-soluble polymer, and further comprises, or consists of, a third lipid material which may be the same as, or different from, the first and/or second lipid material. Suitable examples of lipid materials employed as a third lipid material in a top-coating for the ingestible particles of the invention include, but are not limited to palm stearin (e.g. Prifex® 300; Brenntag N.V.) or tripalmitin (e.g. Dynasan® 116), lauroyl polyoxyl-32 glycerides NF (e.g. Gelucire® 44/14), stearoyl polyoxyl-32 glycerides NF (e.g. Gelucire® 50/13) or caprylocaproyl polyoxyl-8 glycerides NF (e.g. Labrasol®) or a long chain fatty acid monoglyceride or blends thereof; e.g. monopalmitin (glycerol monopalmitate, GMP) monostrearin (glycerol monostearate, GMS), alone or in combination with other further monoglycerides.

Similar to the application of the first and/or second intimate mixture onto inert cores, the top-coating may also be applied using a (spray) coating process in a fluidised bed coater or rotary coater.

The embodiments with such top-coatings are particularly useful in that the top-coating allows for convenient oral administration without the water-swellable or water-soluble polymer interacting with, or sticking to, the mucosa of the mouth or oesophagus during ingestion, as the coating acts as a protective layer. Therefore, they are most desirable for those ingestible particles which contain water-swellable or water-soluble polymers with mucoadhesive properties. While in the majority of cases, the water-swellable or water-soluble polymer is embedded in and/or coated with the lipid material; when blending the two into intimate mixtures, it is almost impossible to exclude with certainty that a minor fraction of the water-swellable or water-soluble polymer is located at, or close to, the particle's surface and may thus get in contact with the oral mucosa. The top-coating also provides protection against agglomeration and sintering during manufacture, storage and shipping, and contributes to achieving an acceptable shelf life.

The top-coating may consist of the third lipid material (for instance, one or more fatty acid compounds having a melting point or melting range above about 37° C., as defined herein, e.g. from about 38° C. to about 75° C.), and is preferably designed to disintegrate quickly so that the coated core underneath is released quickly after swallowing, e.g. within 10 minutes. For this purpose, the third lipid material of the top-coating may optionally contain one or more fatty acid compounds having a melting point or melting range below about 37° C. (e.g. between about 25° C. and about 37° C.), which melts at body temperature and thus ‘weakens’ the top-coating and promotes disintegration. Alternatively, or in addition, the top-coating may further comprise a hydrophilic compound such as a hydrophilic polymer intimately mixed with the third lipid material, e.g. as a disintegration enhancer. Disintegration enhancement may be achieved by various mechanisms, depending on the choice of the disintegration enhancer. For example, a hydrophilic polymer type disintegrant, such as crospovidone, croscarmellose, low-substituted hypromellose (L-HPMC) or even ion-exchange resins, may rapidly take up water, expand in volume and thereby cause the disruption of the top-coating. Non-swelling, highly water-soluble excipients such as sugars or sugar alcohols in the top-coating, on the other hand, may predominantly act as pore formers by which water channels are created. Preferably, the hydrophilic polymer chosen as a disintegrant is different from the water-swellable or water soluble polymer embedded inside the ingestible particles, and has no, or only a low degree, of mucoadhesiveness.

Furthermore, some of the optional components of the first and/or second ingestible solid formulations—in particular those with a rather low dose of up to only a few milligram—may be incorporated in the top-coating rather than, or in addition to, incorporating them into the first and/or second intimate mixture. For instance, lipophilic vitamins may be incorporated in the third lipid material of the top-coating.

In a specific embodiment, the ingestible particles of component A comprise a first ingestible solid formulation a top-coating consisting of, or comprising, a third lipid material as described above; in combination with a component B which comprises at least a second ingestible solid formulation, different from the first, and no top-coating with the third lipid. It will be apparent to a person skilled in the technical field that the choice of the most suitable process for preparing the intimate mixture, processing it into the shape and size of ingestible particles according to the invention, and optionally applying a top-coating to said ingestible particles, may vary depending e.g. on material properties.

Furthermore, it will be apparent that after all processes for the preparation of the ingestible particles briefly summarised above, a subsequent step of classifying the resulting ingestible particles using one or more sieve may be useful in order to obtain particles of a desired sieve diameter range and a more uniform particle size distribution of the final particle population. Where necessary or useful, the particles may be dried prior to classifying them; e.g. at 25° C. under vacuum.

As an alternative to the above described particulate forms (a) granules, pellets and/or minitablets of 0.05-3 mm; b) flakes, shavings, chips and/or sprinkles of 0.01-10 mm), the second ingestible solid formulation in component B may also be provided in the form of a non-particulate matrix, such as in the form of a snack-bar comprising the second intimate mixture and optionally a further comestible material. Alternatively, the second intimate mixture may form a layer on a further comestible material such as cereal flakes, soy puffs or rice puffs.

Instead of shaping the intimate mixture into a particulate ingestible formulation, the second intimate mixture may also be provided in non-particulate forms; i.e. with the second intimate mixture remaining a substantially coherent matrix. In one embodiment, the second intimate mixture is provided in the form of a snack-bar, optionally in combination with further comestible materials. For instance, the second intimate mixture may be applied onto, or in between, layers of crispbread or wafers to form sandwich type, ready-to-eat snack bar. Alternatively, the second intimate mixture may be employed as a binder and blended e.g. with cereals such as rolled oats, dried fruits or vegetables, seeds, nuts, protein powders, and/or sweeteners and then formed into a muesli bar type edible product.

In this non-particulate form, the ingestible solid formulation typically requires chewing by the consumer in order to form smaller, swallowable pieces; said chewed pieces then behaving similar in vivo as the smaller ingestible particles of the invention, such as the granules, pellets and/or minitablets.

In one embodiment, the second intimate mixture forms a layer on a further comestible material such as cereal flakes (e.g. corn flakes, spelt flakes etc.), soy puffs or rice puffs; the resulting ingestible solid formulation may be referred as ‘crunchier’, or ‘crispies’. This embodiment resembles the coating of intimate mixtures onto inert cores, such as sugar crystals as described above. However, the ‘crunchier’ are typically larger than the preferred 0.05 to 3 mm of the coated granules, pellets and/or minitablets. And it cannot be excluded for sure that edible goods such as cereal flakes, soy puffs, rice puffs and the like do participate to a small extent in the satiety effect induced by the second ingestible solid formulation, so that these materials cannot be considered as substantially inert. In addition, the second intimate mixture does not necessarily contribute at least about 50% to the weight of the total particle/‘crunchy’, or at least about 60%, or even at least about 70%, as would be desired when applying it onto inert starter cores. A further difference is that the layer of the second intimate mixture formed on a further comestible material such as cereal flakes is not necessarily applied as a (spray)coating in a fluidised bed or rotary coater; instead the comestible material(s) may simply be added to a melt of the second intimate mixture, blended in carefully and spread out to solidify. Optionally, and depending on the properties of the further components in the second ingestible solid formulation, the blend of the comestible material(s) and the second intimate mixture may even require a step of baking in an oven, before breaking up the solidified and/or baked formulation into particles, the so-called ‘crunchier’ of roughly 10 mm thickness and size similar to drops, or bonbons.

In one embodiment, the first and/or second lipid material comprises a medium or long chain fatty acid compound exhibiting a melting point of higher than 37° C., or from 38° C. to 75° C., or from 40° C. to 70° C. The first and/or second water-swellable or water-soluble polymer may be selected from:
cellulose ethers, pectins, alginic acid, poly(acrylic acid), poly(methacrylic acid), copolymers of acrylic and methacrylic acid, poly(hydroxyethyl methacrylic acid), chitosan, gellan gum, guar gum, xanthan gum and gum arabic, or respective salts thereof; or
water-soluble polysaccharides based on glucose or fructose having an average degree of polymerisation from 2 to 100, or from 4 to 80 and being resistant to digestion in the human small intestine.

Examples of such ingestible particles, their effects and in particular the above-mentioned materials have already been described in more detail in co-pending patent applications PCT/EP2015/068501 or EP15202552.4, which are incorporated herein by reference, and summarised below.

The first and/or second lipid material comprises a medium or long chain fatty acid compound with a melting point of higher than 37° C., or from 38° C. to 75° C., or from 40° C. to 70° C., as defined above. A medium chain fatty acid, as used herein, is understood as a fatty acid with an acyl residue of 6 to 12 carbon atoms, whereas a long chain fatty acid means a fatty acid with an acyl chain of 13 to 21 carbon atoms. Among the preferred medium chain fatty acids are capric acid (C10) and lauric acid (C12), including their esters, in particular their mono-, di- and triglycerides. Examples of preferred long chain fatty acids include myristic acid, palmitic acid, stearic acid, arachidic acid, myristoleic acid, palmitoleic acid, sapienic acid, oleic acid, linoleic acid, linolenic acid and eicosapentaenoic acid, and the respective glycerides thereof.

Further, the medium or long chain fatty acid glyceride compound may represent a native, synthetic or semisynthetic material. In one embodiment, the fatty acid glyceride compound is a native material, i.e. obtained from a natural source by extraction, but without chemical modification. For example, a native or natural triglyceride is not hardened or hydrogenated.

In some embodiments, the first and/or second lipid material comprises a blend of different fatty acid compounds; for instance, a fatty acid glyceride in a blend with a free fatty acid, or more than one fatty acid glyceride (e.g. a blend of mono- di- or triglycerides). In these embodiments, at least the fatty acid glyceride compound and/or at least one of the fatty acid glyceride compounds has a melting point or melting range of higher than 37° C. A number of such fatty acid compound blends suited for the present invention will become apparent from the described embodiments and examples herein.

As mentioned before, the first and second ingestible solid formulations are different from one another. This does not preclude that the first and second lipid material may be identical, or the first and second water-swellable or water-soluble polymer may be identical in some cases. The differences between the first ingestible solid formulation in component A and the second ingestible solid formulation in component B will be detailed below, starting with component A.

In one embodiment, the first lipid material in the first intimate mixture comprises a triglyceride, a blend of partial fatty acid glycerides, and/or a blend of a triglyceride with a partial fatty acid glyceride. In a more specific embodiment, the first lipid material in the first intimate mixture comprises a triglyceride, a blend of partial fatty acid glycerides, and/or a blend of a triglyceride with a partial fatty acid glyceride; and the first water-swellable or water-soluble polymer in the first intimate mixture comprises a cellulose ether, an alginate, a pectin and/or a xanthan.

In one embodiment, medium or long chain fatty acid glyceride compounds are used which have a high content of triglycerides with at least 60 wt.-% triglycerides, or at least 70 wt.-% triglycerides, or at least 80 wt.-% triglycerides, or at least 90 wt.-% triglycerides. Optionally, the fatty acid glyceride compound substantially consists of triglyceride(s).

For instance, in one of the preferred embodiments, the first lipid material in the first intimate mixture is a fractionated but non-hydrogenated palm stearin or palm kernel stearin. Palm stearin is the solid fraction of palm oil that is produced by partial crystallization at controlled temperatures. A particularly preferred commercial quality is Prifex® 300 such as obtainable from Sime Darby Unimills or Brenntag N.V. Further suitable examples of fatty acid glyceride compounds having a high content of triglycerides, or even consisting thereof, include but are not limited to tripalmitin (e.g. Dynasan® 116), tristearin (e.g. Dynasan® 118) and solid triglyceride-based hard fats such as Witepsol® E85 or Witepsol® W25.

In one embodiment, the first lipid material in the first intimate mixture comprises a fractionated but non-hydrogenated palm stearin or palm kernel stearin; and the first water-swellable or water-soluble polymer in the first intimate mixture comprises a sodium alginate. In a more specific embodiment, the first lipid material in the first intimate mixture comprises a fractionated but non-hydrogenated palm stearin or palm kernel stearin and an omega-3 oil and/or an omega-6-oil; and the first water-swellable or water-soluble polymer in the first intimate mixture comprises a sodium alginate, a pectin and a beta-glucan.

The terms ‘omega-3 oil’ and ‘omega-6 oil’ simply refer to oils of vegetable or animal origin which are known to are rich in omega-3-fatty acids such as α-linolenic acid (ALA), eicosapentaenoic acid (EPA) or docosahexaenoic acid (DHA), and omega-6 fatty acids such as linoleic acid (LA) or arachidonic acid (AA), respectively. Examples of suitable omega-3 oils and omega-6-oils will be provided further below, when coming to component B in further detail.

As will be detailed further below, omega-3 and/or omega-6 oils, alone or in combination, may not only be added as, or to, the lipid material, but may also be provided as a separate, independent component B.

In another preferred embodiment, the fatty acid glyceride compound comprises one or more partial glycerides of a medium or long chain fatty acid, in particular monoglycerides of a medium or long chain fatty acid. For example, monoolein (glycerol monooleate, GMO), monostearin (glycerol monostearate, GMS), or monolaurin (glycerol monolaurate, GML) are very suitable for carrying out the invention, individually or in combination with each other. For the present invention, a monoglyceride such as monoolein, monostearin or monolaurin may be incorporated as a substantially pure compound or as a mixture of mono- and diglycerides or even mono-, di- and triglycerides with various fatty acids, but with a high content (“enriched”) of a particular monoglyceride compound. For example, a monoolein or monolaurin grade may be used which comprises at least about 40% (or at least about 50%, or 60% or 70% or 80% or 90%) of the actual monoglyceride of oleic or lauric acid, respectively.

Thus, in one of the preferred embodiments, the first lipid material in the first intimate mixture comprises a blend of glycerol monolaurate (GML) and glycerol monooleate (GMO). In a more specific embodiment, the first lipid material in the first intimate mixture comprises a blend of glycerol monolaurate (GML) and glycerol monooleate (GMO), and the first water-swellable or water-soluble polymer in the first intimate mixture comprises a cellulose ether selected from hydroxyethyl cellulose, hydroxypropyl cellulose, hydroxypropyl methylcellulose (HPMC), methylcellulose (MC), and carboxymethylcellulose (CMC); preferably hydroxypropyl methylcellulose (HPMC). In a further specific embodiment, the first lipid material in the first intimate mixture comprises a blend of glycerol monolaurate (GML), glycerol monooleate (GMO) and a triglyceride, and the first water-swellable or water-soluble polymer in the first intimate mixture comprises hydroxypropyl methylcellulose (HPMC), and optionally a xanthan.

In another preferred embodiment, the first lipid material in the first intimate mixture comprises a blend of glycerol monostearate (GMS) and glycerol monooleate (GMO). In one embodiment, the first lipid material in the first intimate mixture comprises a blend of glycerol monostearate (GMS) and glycerol monooleate (GMO); and the first water-swellable or water-soluble polymer in the first intimate mixture comprises a cellulose ether selected from hydroxyethyl cellulose, hydroxypropyl cellulose, hydroxypropyl methylcellulose (HPMC), methylcellulose (MC), and carboxymethylcellulose (CMC); preferably hydroxypropyl methylcellulose (HPMC), and optionally a xanthan gum.

In a more specific embodiment, the first lipid material in the first intimate mixture comprises a blend of glycerol monostearate (GMS), glycerol monooleate (GMO) and one or more triglyceride-based hard fats (Adeps solidus); and the first water-swellable or water-soluble polymer in the first intimate mixture comprises hydroxypropyl methylcellulose (HPMC), and optionally a xanthan gum.
In a further specific embodiment, the first lipid material in the first intimate mixture comprises a blend of glycerol monostearate (GMS), glycerol monooleate (GMO), and one or more triglyceride-based hard fats (Adeps solidus); the first water-swellable or water-soluble polymer in the first intimate mixture comprises hydroxypropyl methylcellulose (HPMC), and optionally a xanthan gum; and the first intimate mixture further comprises a medium or long chain fatty acid salt.
In a yet further specific embodiment, the first lipid material in the first intimate mixture comprises a blend of glycerol monostearate (GMS), glycerol monooleate (GMO), and one or more triglyceride-based hard fats; the first water-swellable or water-soluble polymer comprises hydroxypropyl methylcellulose (HPMC), and optionally a xanthan gum; and the first intimate mixture further comprises a sodium salt or potassium salt or calcium of stearic acid, e.g. sodium stearate.

Optionally, the triglyceride-based hard fats employed in the above embodiments of the first intimate mixture may be selected from Witepsol®-grades (Nordmann Rassmann GmbH, Germany), for instance from Witepsol® E85 or Witepsol® W25; or from Dynasan®-grades (Cremer-Oleo, Germany), for instance from Dynasan ® 116 or Dynasan® 118.

Suitable examples for water-swellable or water-soluble polymers have already been described in more detail in previous applications, for instance in PCT/EP2015/068501 or in EP15202552.4, which are incorporated herein by reference.

In summary, the first water-swellable or water-soluble polymer may be one or more compounds selected from the following:
poly(carboxylates), preferably poly(acrylic acid), poly(methacrylic acid), copolymers of acrylic and methacrylic acid, copolymers of acrylic or methacrylic acid and maleic acid, carbomers (e.g. Carbopol®, Pemulen®, Polygel®, Synthalen®, Acritamer® or Tego Carbomer®) or polyarbophils (Noveon®) and their respective commercially available grades);
water-swellable or water-soluble plant fibres, such as psyllium seed husk;
cationic polysaccharides such as chitosan, in particular chitosan derived from fungi or derived by deacetylation of chitin;
anionic polysaccharides including carboxymethylcellulose (CMC), sodium alginate, propylene glycol alginate, pectin, xanthan gum, alginic acid, hyaluronan, carrageenan, gellan gum, tragacanth; or alternatively, fucoidan, chondroitins; hyaluronic acids, modified starches such as octenyl succinate starches or, karaya gum, xylans, or anionic dietary fibres (i.e. carbohydrate polymers with ten or more monomeric units which are not hydrolysable by endogenous enzymes in the small intestine);
non-ionic polysaccharides such as cellulose ethers, in particular HPMC, beta glucans such as oat or barley beta glucan, locust bean gum, konjac gum, guar gums, galactomannans, glucomannans, inulins and dextrins such as resistant dextrin.

In one embodiment, the first water-swellable or water-soluble polymer may be selected from:
cellulose ethers, pectins, alginic acid, poly(acrylic acid), poly(methacrylic acid), copolymers of acrylic and methacrylic acid, poly(hydroxyethyl methacrylic acid), chitosan, gellan gum, guar gum, xanthan gum and gum arabic, or respective salts thereof;
water-soluble polysaccharides based on glucose or fructose having an average degree of polymerisation from 2 to 100, or from 4 to 80 and being resistant to digestion in the human small intestine.

In one of the preferred embodiments the first water-swellable or water-soluble polymer may be selected from carboxymethylcellulose (CMC), HPMC, sodium alginate, pectin, xanthan gum, beta-glucans such as oat or barley beta glucan, inulins, dextrins such as resistant dextrin; and preferably combinations thereof.

In addition to the, first ingestible solid formulation component A may optionally further comprise a powder, powder blend or granulate comprising a protein and/or a thickening agent. Same as with any of the other optional components that may be contained in the kit component A (i.e. components other than the ingestible solid formulation in the form of particles), this is in particular useful if the amounts, alone or combined with each other, are larger and may, for instance, potentially interfere with the embedding of the first water-swellable or water-soluble polymer in the first lipid material. (Same applies in analogy to any optional components incorporated in the second ingestible intimate mixture.)

If present, this powder, powder blend or granulate will be mixed, e.g. by simple dry-blending, with the first ingestible solid formulation and packaged together as component A of the kit. The main purpose of this protein and/or thickening agent is to slightly increase the viscosity of an aqueous ingestible liquid (e.g. water, milk, juice), which may e.g. be filled into the glass vial, or bottle, housing component A in order to disperse the ingestible particles and form a smooth drink formulation, or drink suspension, with the aim that the consumer does not feel the need to chew the ingestible particles during oral ingestion.
Where on the other hand an actual supplement with a nutritional protein and/or vitamin is intended, the amounts of said protein and/or vitamin may commonly take larger weights and/or volumes; thus it may then be advisable to provide the protein and/or vitamin supplement powder, powder blend or granulate separate from component A, e.g. as component B.

The protein in this powder, powder blend or granulate comprises an isolate and/or concentrate of a milk protein, a whey protein, a soy protein, a pea protein, a brown rice protein and/or a wheat protein, and optionally one more vitamins; e.g. a vitamin selected from retinol, retinal, beta carotene, thiamine, cyanocobalamine, hydroxycyanocobalamine, methylcobalamine, riboflavin, niacin, niacinamide, pantothenic acid, pyridoxine, pyridoxamine, pyridoxal, biotin, folic acid, folinic acid, ascorbic acid, cholecalciferol, ergocalciferol, tocopherol, tocotrienol, phylloquinone, and menaquinone.

Examples of suitable protein powders include but are not limited to pure concentrates and/or isolates of milk-protein, soy protein, pea protein, brown rice protein or whey protein; or ready-made, usually flavoured preparations thereof e.g. preparations containing
whey protein concentrate (74%), natural banana flavouring, natural strawberry flavouring, banana powder, strawberry powder, colour (curcumin, beetroot red), sweetener sucralose and soy lecithin
soy protein isolate (40.5%), honey, skimmed milk powder, yoghurt powder, maltodextrin, soy oil, inulin, milk protein, dipotassiumphosphate, tri-calciumphosphate, silicon dioxide, magnesium hydroxite, soy lecithin, L-ascorbic acid, iron-(III)-diphosphate, steviol glycoside, niacin, DL-alpha-tocopherol, zinc oxide, manganese-(II)-sulphate, copper carbonate, calcium-D-panthotenate, colouring beta-carotene, pyrodixine hydrochloride, thiaminmononitrate, riboflavin, retinylacetate, pteroylmonoglutamic acid, potassium iodide, sodium selenite, D-biotin, cholecalciferol, cyanocobalamin
soy protein (50%), honey, skimmed milk-yoghurt powder, potassium chloride, magnesium citrate, silicic acid, calcium citrate, vitamin C, niacin, colouring riboflavin, vitamin E, zinc oxide, iron fumarate, manganese sulphate, calcium-D-panthotenate, vitamin B2, vitamin B6, vitamin B1, vitamin A, folic acid, potassium iodide, sodium selenite, biotin, vitamin D3, vitamin B12
protein enriched whey powder, milk protein, soy protein isolate, wheat protein, low-fat cocoa powder, carboxymethyl cellulose, flavour, maltodextrin, caramel sugar, sodium cyclamate, sodium saccharin, magnesium hydroxide, palm oil, ferric pyrophosphate, L-ascorbic acid, DL-a-tocopherylacetate, nicotinamide, silicon dioxide, zinc oxide, calcium-D-pantothenate, manganese sulphate, cholecalciferol, cupric carbonate, pyridoxine hydrochloride, riboflavin, thiamin mononitrate, retinyl acetate, folic acid, sodium selenite, sodium iodide, D-biotin, cyanocobalamin.

The same proteins or protein formulations may also be used as component B or as part of component B.

Examples of suitable thickening agents include but are not limited to carbomers, agar, gelatine, pectin, carrageenan, alginic acid derivatives, locust bean gum, xanthan gum, tragacanth, chitosan, pullulan, curdlan, psyllium seed husks, wheat-derived dextrins and cellulose derivatives. Carboxymethylcellulose (CMC), in particular sodium-CMC, xanthan gum or guar gum are preferred for the present invention.

For consumption, the ingestible particles of component A are typically dispersed in ingestible, preferably non-carbonated liquids or semi-solids, e.g. water, milk, juice, yoghurt, pudding, and the like. Smaller particles like the granules, pellets or minitablets of 0.05-3 mm may, for instance, be dispersed in water, juice, milk, whey or other dairy beverages to form a drinkable suspension. Larger particles like the flakes, shavings, chips or sprinkles of 0.01-10 mm may be blended into soft, semisolid foods such as yoghurt, pudding, fruit or vegetable purées or the like. Of course, the consumer is free to decide to consume component A as is; e.g. eating flakes of the ingestible solid formulation right out of the single dose package; the satiety inducing effect will nonetheless be achieved in the same way.

In one specific embodiment of component A, the first ingestible solid formulation first consists of a first intimate mixture consisting of:
hydroxypropyl methylcellulose (HPMC; e.g. AnyAddy® CN10T), and optionally a xanthan gum;
a sodium salt or potassium salt or calcium salt of stearic acid (e.g. sodium stearate EP 7.0);
and a first lipid material consisting of:
   glycerol monostearate (GMS; e.g. GMS 90 food),
   glycerol monooleate (GMO; e.g. Imwitor® 990),
   a triglyceride-based hard fat with a melting point of 33.5° C. to 35.5° C. (such as Witepsol® W25), and
   a triglyceride-based hard fat with a melting point of 42° C. to 44° C. (such as Witepsol® E85);
optionally a sugar, a sugar alcohol, an amino acid, a protein, a vitamin, a micro-nutrient and/or a further dietary element selected from the compounds as disclosed herein
and a top-coating consisting of one or more fatty acid compounds selected from palm stearin (e.g. Prifex® 300), tripalmitin (e.g. Dynasan® 116), lauroyl polyoxyl-32 glycerides NF (e.g. Gelucire® 44/14), stearoyl polyoxyl-32 glycerides NF (e.g. Gelucire® 50/13), caprylocaproyl polyoxyl-8 glycerides NF (e.g. Labrasol®) or a long chain fatty acid monoglyceride selected from glycerol monopalmitate or glycerol monostearate.

In a further specific embodiment of component A, the first ingestible solid formulation first consists of a first intimate mixture consisting of hydroxypropyl methylcellulose (HPMC); sodium stearate and a first lipid material consisting of glycerol monostearate (GMS), glycerol monooleate (GMO), a triglyceride-based hard fat with a melting point of 33.5° C. to 35.5° C. (namely Witepsol® W25), and a triglyceride-based hard fat with a melting point of 42° C. to 44° C. (namely Witepsol® E85); and a top-coating consisting of glycerol monostearate (GMS).

In a yet further specific embodiment of component A, the first ingestible solid formulation first consists of a first intimate mixture consisting of hydroxypropyl methylcellulose (HPMC); sodium stearate and a first lipid material consisting of glycerol monostearate (GMS), glycerol monooleate (GMO), a triglyceride-based hard fat with a melting point of 33.5° C. to 35.5° C. (namely Witepsol® W25), and a triglyceride-based hard fat with a melting point of 42° C. to 44° C. (namely Witepsol® E85); and a top-coating consisting of glycerol monostearate (GMS);

together with a ‘drink powder mixture’ comprising, or consisting of, protein enriched whey powder, milk protein, soy protein isolate, wheat protein; wheat-derived dextrin, psyllium seed husk (finely ground), sodium carboxymethylcellulose and xanthan gum as thickening agents; maltodextrin, sunflower lecithin, magnesium hydroxide, silicon dioxide; caramel sugar, low-fat cocoa, sodium cyclamate, sodium saccharin; L-ascorbic acid, DL-a-tocopherylacetate, nicotinamide, calcium-D-pantothenate, manganese sulphate, cholecalciferol, zinc oxide, ferric pyrophosphate, cupric carbonate, pyridoxine hydrochloride, riboflavin, thiamine mononitrate, retinyl acetate, folic acid, sodium selenite, sodium iodide, D-biotin and cyanocobalamin.

Any of the above-described kit components A may be combined in the form of a kit with any of kit components B as will be described below.

As mentioned, component B may be selected from an oil comprising an unsaturated fatty acid compound, a vitamin, or combinations thereof; a powder, or powder-blend or granulate comprising a protein, a vitamin, a micro-nutrient, a dietary element, a dietary fibre, an amino acid or combinations thereof; and/or a second ingestible solid formulation.

The oil comprising an unsaturated fatty acid compound (e.g. an unsaturated fatty acid or an unsaturated fatty acid ester, such as a mono-, di- or triglyceride) may be selected from olive oil, palm oil or coconut oil, omega-6 oils, or omega-3 oils; or combinations thereof.

Examples of omega-6 oils suitable for the invention include but are not limited to safflower seed oil, sunflower oil, grape seed oil, wheat germ oil, pumpkin seed oil, evening primrose oil, soy-bean oil, walnut oil or corn oil; Examples of omega-3 oils suitable for the invention include but are not limited to linseed oil (or flaxseed oil), rape seed oil, hemp seed oil, clary sage seed oil, algae oil, Sacha Inchi oil, Echium oil, fish oil, squid oil or krill oil.

It should be noted that typically most of the above-named oils contain both, omega-3 and omega-6 fatty acids, and that therefore the assignment of an oil to either omega-3 or omega-6 may in some cases vary depending on the literature source consulted.

Optionally, each of these oils—alone or in combination—may be provided in a powdered form; i.e. as a so-called fat-powder or oil-powder. Such powders are commercially available for instance from Bressmer & Francke (Norderstedt, Germany), where a carrier of tapioca-maltodextrin is ‘loaded’ with 65-67% oil (hence the addition of “powder 67” after the name of the oils for the commercial Bressmer products).

Examples of suitable oil powders include 3-seeds oil powder, cotton seed oil powder, CLA powder (conjugated linoleic acid), thistle oil powder (safflower oil), fish oil powder 18/12 (with 18% EPA/12% DHA), hemp seed oil powder, coconut oil powder, pumpkin seed oil powder, salmon oil powder, corn oil powder, MCT (medium-chain triglycerides) powder, evening primrose oil powder, olive oil powder, omega-3 powder, palm oil powder, palm olein powder, rapeseed oil powder, soya bean oil powder, sunflower oil powder, grape seed oil powder and wheat germ oil powder.

The oil—or optionally the oil powders—may e.g. be provided in a vial, ampoule, bottle, sachet, stick pack, foil or plastic bags, or in a filled straw; or alternatively, the oil maybe held in so-called dosing cap; i.e. a reservoir in the cap of a bottle which is separated from the inner volume of the bottle, e.g. by a heat-sealed aluminium foil. The selection of the package will be guided by a) the volume to be packaged, as well as b) stability considerations, such as the potential need to provide protection from light, oxygen etc.. Furthermore, when oil powders are used, these may optionally be combined with other pulverulent goods in component B (such as the powder, or powder-blend or granulate comprising a protein, a vitamin, a micro-nutrient, a dietary element, a dietary fibre, an amino acid or combinations thereof, and/or with the powder, powder-blend or granulate comprising a flavourant), wherever this is considered expedient, e.g. with regard to flow properties, volume-and/or handling considerations.

As mentioned above for component A, vitamins may be selected from retinol, retinal, beta carotene, thiamine, cyanocobalamine, hydroxycyanocobalamine, methylcobalamine, riboflavin, niacin, niacinamide, pantothenic acid, pyridoxine, pyridoxamine, pyridoxal, biotin, folic acid, folinic acid, ascorbic acid, cholecalciferol, ergocalciferol, tocopherol, tocotrienol, phylloquinone, and menaquinone. In cases where an oil is provided as component B, this may be used advantageously to mix in lipid-soluble vitamins (such as vitamins A, D, E and K) and/or oxidation-sensitive vitamins (such as folic acid) together with said oil.

The term ‘micro-nutrients’ refers to nutrients which are required by e.g. humans in small quantities for a variety of their physiological functions, their proper growth and development. They include, for instance, dietary micro-minerals or trace elements in amounts generally less than 100 mg/day (as opposed to macro-minerals). The micro-minerals or trace elements include at least boron, bromine, cobalt, chromium, copper, fluoride, iodine, iron, manganese, molybdenum, selenium, or zinc. Micronutrients further include phytochemicals, such as terpenoids or polyphenolic compounds, as well as vitamins (i.e. some compounds may qualify for both categories, vitamins and micro-nutrients). Preferred micro-nutrients according to the invention may be selected from organic acids, such as acetic acid, citric acid, lactic acid, malic acid, or taurine; and trace—or micro-minerals such as salts of boron, bromine, cobalt, chromium, copper, fluoride, iodine, iron, manganese, molybdenum, selenium, or zinc (optionally present in ionised or complexed form or as a salt, an oxide or a chelated salt); choline and cholesterol.

The term ‘dietary element’, often also referred to as an essential element, dietary mineral or mineral nutrient, describes a chemical element that is physiologically required by the human body. Dietary elements are sometimes classified in various groups. For example, one group consist of hydrogen, carbon, nitrogen and oxygen, and is considered the basis of life and the quantitative basis of most organic compounds that play a role in human physiology. Another group which consists of sodium, potassium, magnesium, calcium, phosphorus, sulphur, and chlorine is often termed the quantitative elements or macro minerals, as these elements are physiologically required in substantial amounts. The remaining elements are referred to as micro-minerals (see above under micro-nutrients), trace elements, or essential trace elements, as the amount that is physiologically required is very small.

Dietary fibres for component B may be selected from soluble and/or insoluble dietary fibres. The soluble dietary fibre is preferably a prebiotic or natural gum; and the insoluble fibre is preferably a cellulose, lichenin, chitin, hemicellulose, or lignin. As used herein, a prebiotic is a compound or material that supports the growth of micro-organisms that are hosted by a human and that are beneficial to the host. In particular, a compound or material that is a substrate for the gut microbiome of a human is an example of a prebiotic. Many but not all currently known prebiotics are fibres.

Suitable prebiotic fibres include for example inulin, galacto-oligosaccharides, mannan oligosaccharides, and gum arabic. Optionally, component B may comprise the prebiotic fibre in the form of a plant extract which is rich in such fibre, such as extracts from chicory root, asparagus, leek, Jerusalem artichoke, dandelion, garlic, onion, wheat bran, beans, oats, or banana.

As used herein, a natural gum is a native or modified soluble polysaccharide, or polysaccharide-containing polymer, that substantially increases the viscosity when dissolved in an aqueous medium even at relatively low concentrations. Hence, soluble fibres may also be referred to as viscous fibres. The natural gum may be selected from the group of natural gums representing largely uncharged compounds, or from the group of charged gums, or polyelectrolytes.

Suitable uncharged natural gums may be derived from bacteria, such as xanthan gum, or from botanical sources, such as Psyllium seed husks, glucomannan, guar gum, beta-glucan, locust bean gum, chicle gum, mastic gum, tara gum, spruce gum or dammar gum. Suitable natural polyelectrolyte gums include for example gums from seaweeds, such as agar, alginic acids and alginates, carrageenan; or charged gums from bacteria, such as gellan gum; or from other botanical sources such as gum arabic, gum ghatti, gum tragacanth, pectin, or Karaya gum.

An insoluble fibre is understood as a fibre which is substantially insoluble in water at physiological pH and body temperature. Suitable insoluble fibres include non-starch polysaccharides such as cellulose, lichenin, chitin, hemicellulose, or lignin. Optionally, component B comprises such insoluble fibres in the form of a plant material or plant extract, such as wheat bran, corn bran, or fibre-enriched vegetable or fruit powders.

Component B may of course also comprise a mixture of different fibres, whether from the same or different categories. If present in component B, the dietary fibre may be incorporated at any suitable amount, and preferably at an amount of up to about 50 g per single dose of the composition. Also preferred are amounts from about 0.5 g to about 40 g, or from about 1 g to about 30 g, or from about 2 g to about 25 g, respectively.

Kit component A is a satiety inducing component intended to replace meals fully or partially. Such meal replacement may leave consumers wondering, or even worrying, whether they still get enough nutrients in terms of dosing, and/or whether they receive the right nutrients during their dietary regimen. Hence, to supplement nutrients such as proteins, amino acids, vitamins, micro-nutrients or further dietary elements, and/or dietary fibres during a dieting schedule by adding them to a kit with component A improves the compliance of consumers as well as the overall safety of dieting/weight loss regimens, in that the consumer is less likely to receive insufficient amounts of nutrients throughout the time-span of the regimen; or on the contrary less likely to unintentionally overdose on nutrients. The latter is of particular importance in respect of, for instance, any nutrients which the body is known or suspected to accumulate; e.g. lipophilic vitamins A, D, E and K.

Further it is apparent, that some of the dietary fibres listed above may also be suitable for being incorporated as the second water-swellable or water-soluble polymer into the second ingestible solid formulation of component B, together with the second lipid material, as will be described below.

In one embodiment, the second lipid material in the second intimate mixture comprises a triglyceride. In a more specific embodiment, the second lipid material comprises a triglyceride; and the second water-swellable or water-soluble polymer in the second intimate mixture is selected from a dextrin having a degree of polymerisation from 4 to 40, or from 10 to 30, preferably from 12 to 25; or an inulin having a degree of polymerisation from 4 to 60, or from 5 to 25. Furthermore, the second ingestible solid formulation contains not more than 5% mucoadhesive polymer in this embodiment. Optionally, the content of the mucoadhesive polymer in the second ingestible solid formulation is not more than 4%, or not more than 3%, or not more than 2%, or not more than 1%, respectively. Preferably, the second intimate mixture contains not more than 5% mucoadhesive polymer, or optionally not more than 4%, or not more than 3%, or not more than 2%, or not more than 1%, respectively.

This means that—unlike the first intimate mixture which may comprise water-swellable or water-soluble polymers with mucoadhesive properties (e.g. alginates, pectins, or xanthans)—the second intimate mixture of kit component B comprises only very limited amounts of such mucoadhesive polymers.

In one of the preferred embodiments, the second ingestible solid formulation—and/or the second intimate mixture comprised in it—are free or substantially free of mucoadhesive polymers; or in other words, the second intimate mixture may essentially consist of the second lipid material, the second water-swellable of water-soluble polymer; and optionally one or more further excipients without mucoadhesive properties, such as medium or long chain fatty acid salts, sugars, sugar alcohols, vitamins, amino acids, proteins, micro-nutrients and/or further dietary elements. Due to this lack of mucoadhesiveness, the second ingestible solid formulation typically does not require a top-coating; however, where such coatings are considered expedient for other reasons (such as increased storage stability or the like), coatings may also be applied to the second ingestible solid formulation, in particular where provided in particulate form.

Examples of water-swellable or water soluble polymers of the invention which reportedly exhibit mucoadhesive properties include:
a) poly(carboxylates) such as poly(acrylic acid) (optionally in crosslinked form, e.g. carbomers like Carbopol® or polycarbophils like Noveon® AA-1), poly(methacrylic acid), copolymers of acrylic and methacrylic acid, and poly(hydroxyethyl methacrylic acid), alginic acid or salts thereof, or pectins;
b) cellulose ethers such as CMC, HEC, HPC, HPMC, and MC
c) mucoadhesive polysaccharides like chitosan, gellan gum, guar gum, or xanthan gum, and
d) gum arabic (a mixture of glycoproteins and polysaccharides).

If any of these compounds are present in the second ingestible solid formulation, their amount should be limited to not more than 5%.

In one of the preferred embodiments, the second lipid material in the second intimate mixture comprises, or consists of, a triglyceride; and the second water-swellable or water-soluble polymer in the second intimate mixture is selected from a dextrin having a degree of polymerisation from 4 to 40, or from 10 to 30, preferably from 12 to 25; and the second ingestible solid formulation contains not more than 5% mucoadhesive polymer.

In a more specific embodiment of the second ingestible solid formulation the second lipid material in the second intimate mixture comprises, or consists of, a fractionated but non-hydrogenated palm stearin or palm kernel stearin, and wherein the dextrin is a resistant dextrin derived from wheat or maize starch. Such a palm stearin is e.g. commercially available under the name Prifex® 300 (Sime Darby Unimills or Brenntag N.V.). Resistant dextrins are partially hydrolysed starches; i.e. short chain glucose polymers, without sweet taste which are relatively resistant to the hydrolytic action of human digestive enzymes. They can be made for instance from wheat (Nutriose® FB range or Benefiber®) or maize starch (Nutriose® FM range), using a highly controlled process of dextrinisation (heating the starch in the presence of small amounts of food-grade acid), followed by a chromatographic fractionation step. This produces a highly indigestible, yet soluble dextrin, with a high fibre content of about 65-85%, and a narrower, more favourable molecular weight distribution; e.g. approx. 4000 to 6000 Da for Nutriose® 6, or 3500 to 4500 Da for Nutriose® 10 (other dextrins, e.g. one of the starting materials to prepare resistant dextrins, may exhibit broader molecular ranges such as from about 3000 to 10000 Da). During the dextrinisation step, the starch undergoes a degree of hydrolysis followed by repolymerisation that converts it into fibre and results in a drastically reduced molecular weight and the introduction of new glucoside linkages: in addition to the digestible α-1,4 and α-1,6 glycosidic linkages as commonly found in starches and the digestible maltodextrins, also non-digestible glycosidic bonds such as β-1,2 or β-1,3, are formed in resistant dextrins, which cannot be cleaved by enzymes in the digestive tract. As a result, a portion of the dextrin is not digested in the upper part of the gastro-intestinal tract and is not directly available as such for energy utilisation. Further, some commercial suppliers offer grades with different levels of mono- and di-saccharides (e.g. Nutriose® 10>Nutriose® 6, as available from Roquette), while the composition of the higher molecular weight oligomers is the same in both grades.

In one embodiment, the second water-swellable or water-soluble polymer in the second intimate mixture is a polysaccharide component. In a specific embodiment, the second water-swellable or water-soluble polymer in the second intimate mixture comprises, or consists of, a dextrin having a degree of polymerisation from 4 to 40, or from 5 to 40, or from 10 to 30, preferably from 12 to 25. In one embodiment, the second water-swellable or water-soluble polymer, i.e. the polysaccharide component, comprises, or consists of, a dextrin having a dextrose equivalent of not higher than 20, preferably a dextrose equivalent of 5 to 15.

In one embodiment, kits are provided wherein the protein is an isolate and/or concentrate of a milk protein, a whey protein, a soy protein, a pea protein, a brown rice protein and/or a wheat protein; and/or wherein the thickening agent is selected from carbomers, agar, gelatine, pectin, carrageenan, alginic acid derivatives, locust bean gum, xanthan gum, tragacanth, chitosan, pullulan, curdlan, psyllium seed husks, wheat-derived dextrins and cellulose derivatives, preferably from carboxymethylcellulose (CMC), in particular sodium-CMC, xanthan gum or guar gum; and/or wherein the oil is selected from omega-6 oils such as safflower seed oil, sunflower oil, grape seed oil, wheat germ oil, pumpkin seed oil, evening primrose oil, soy-bean oil, walnut oil or corn oil; from omega-3 oils such as linseed oil (or flaxseed oil), rape seed oil, hemp seed oil, clary sage seed oil, algae oil, Sacha Inchi oil, Echium oil, fish oil, squid oil or krill oil; or combinations thereof; and/or wherein the amino acid is selected from
(a) L-amino acids;
(b) the group consisting of L-isoleucine, L-valine, L-tyrosine, L-methionine, L-lysine, L-arginine, L-cysteine, L-phenylalanine, L-glutamate, L-glutamine, L-leucine, and L-tryptophan;
(c) the group consisting of L-phenylalanine, L-leucine, L-glutamine, L-glutamate, and L-tryptophan; or
(d) L-tryptophan;

and/or wherein the sugar or sugar alcohol is selected from mono-or disaccharides including sucrose, fructose and glucose, and polyhydric alcohols including arabitol, erythritol, glycerol, isomalt, lactitol, maltitol, mannitol, sorbitol or xylitol;

and/or wherein the medium or long chain fatty acid salt is selected from the salts of capric acid, lauric acid, myristic acid, palmitic acid, stearic acid, arachidic acid, myristoleic acid, palmitoleic acid, sapienic acid, oleic acid, linoleic acid, linolenic acid and eicosapentaenoic acid, preferably a sodium salt or potassium salt or calcium salt of stearic acid, arachidic acid or oleic acid;

and/or wherein the vitamin is selected from retinol, retinal, beta carotene, thiamine, cyanocobalamine, hydroxycyanocobalamine, methylcobalamine, riboflavin, niacin, niacinamide, pantothenic acid, pyridoxine, pyridoxamine, pyridoxal, biotin, folic acid, folinic acid, ascorbic acid, cholecalciferol, ergocalciferol, tocopherol, tocotrienol, phylloquinone, and menaquinone;
and/or wherein the micro-nutrient is selected from organic acids, such as acetic acid, citric acid, lactic acid, malic acid, or taurine; trace—or micro-minerals such as salts of boron, bromine, cobalt, chromium, copper, fluoride, iodine, iron, manganese, molybdenum, selenium, or zinc (optionally present in ionised or complexed form or as a salt, an oxide or a chelated salt); choline and cholesterol;
and/or wherein the further dietary element is selected from the macro-minerals calcium, chlorine, magnesium, phosphorous, potassium, sodium and sulphur (optionally in ionised or complexed form or as a salt, an oxide or a chelated salt);
and/or wherein the dietary fibre is selected from a prebiotic or natural gum, cellulose, lichenin, chitin, hemicellulose, or lignin.

This applies to any kit of the invention and irrespective of whether the proteins, oils, amino acids, fatty acid salts, sugars, sugar alcohols, vitamins, micro-nutrients, dietary elements and/or dietary fibres are added as a separate component to kit components A and/or B; and/or whether they are incorporated into the first and/or second ingestible solid formulation, or first and/or second intimate mixture.

As mentioned, the components of the kits according to the invention—i.e. at least kit components A and B—are supplied in the form of:
separate compartments of one primary package,
separate primary packages packaged together within one secondary package,
separate primary packages packaged in two or more separate secondary packages which are in turn held together by paper or plastic wrappers, ribbons, sleeves or the like, or any combinations of any of these.

A primary package may be understood as the package which holds, or houses, or contains, the product to be packaged; and typically gets in direct contact with said product. Examples of primary packages include vials, ampoules, bottles, containers, sachets, stickpacks, blister strips, foil or plastic bags, filled straws and the like. Common materials used for primary packages of food and/or pharmaceutical products are known to a person skilled in this field and should be selected, such as to limit any risk of interaction between the packaging material and the packaged product.

Where the primary package contains a single dose of the product, said package may also be referred to as single dose unit, or single dose package.

In one embodiment, a single dose unit, or single dose package, of component A weighs from about 3 g to about 80 g, or from about 3 g to about 60 g, or from about 3 g to about 40 g, or from about 3 g to about 20 g and comprises at least about 2 g of the first lipid material, more preferably at least about 3 g of the first lipid material. In further embodiments, the amount comprised in a single dose of component A is from about 3 g to about 35 g, or from about 3 g to about 30 g, or from about 4 g to about 25 g, or from about 4 g to about 20 g, or from about 4 g to about 15 g, or from about 5 g to about 12 g, or from about 5 g to about 10 g, respectively. It is also preferred that component A exhibits a high content of the first ingestible solid formulation, such as at least about 50%, or at least about 60%, or at least about 70%, or at least about 80%; or at least about 90%, or at least about 95%, or at least about 98%, and up to about 100% by weight. In one specific embodiment, a single dose unit, or single dose package, of component A weighs about 27 g to 29 g, e.g. about 28 g and comprises from about 13 to about 17 g, e.g. 14 g or 15 g, of the first ingestible solid formulation.

Examples of primary packages with separate compartments according to the invention include but are not limited to a sachet, stickpack foil or plastic bags, or filled straw which is divided into two or more ‘sub-pouches’ by a laminating seam; or a vial, ampoule or bottle, e.g. made of glass, which are filled with a first kit component and a second kit component being contained in a separate reservoir, or compartment, formed within the lid, or cap, of said vial ampoule or bottle. This ‘cap reservoir’ is separated from the inner volume of the vial, ampoule or bottle, for instance by means of heat-sealed aluminium foil which is positioned and fixed to the cap, after the reservoir was filled with one of the kit components. Optionally the lid, or cap, may be a snap-fit lid or a screw-top lid. Further optionally, the separate reservoir may be connectable to the inner volume of the vial, ampoule or bottle. In a specific embodiment, the lid, or cap, may be equipped with means which allow the separation between the cap reservoir and the inner volume of the vial, ampoule or bottle, while the lid is attached to bottle. This may be desirable in cases where the first and second kit components A and B are meant to be consumed together, but may not necessarily be suited to be ‘pre-combined’ with each other in a single primary package (e.g. due to instabilities, unsightly colour and/or taste changes upon storage).

Multiples of these primary packages with separate compartments may be packed together in a cardboard-box (or other suited outer packaging), e.g. multiples of 7 for a ‘week-pack’ (if administration of both components is once daily); or multiples of 28 or 31 for a ‘monthly pack’. It is easily understood, that if e.g. twice daily administration is intended, multiples of 14 primary packages may be packed together in a secondary, outer package to form a ‘week pack’; or multiples of 56 or 62 for a ‘monthly pack’; and so on.

Optionally, the secondary packaging may have small dividers, such as folded paper or plastic foil strips, which e.g. help the dosage cap bottles or other compartmented primary packages to stay in place even of the secondary packages is gradually emptied.

Further optionally, written instructions, pictograms or other readable forms of instructions (e.g. barcodes, QR-codes) for the human subject, concerning e.g. the specifics of the oral administration, may be provided as a package insert, printed on the outside of the secondary packaging and/or directly on the primary package, if the latter provides enough surface for prints. In a specific embodiment, the kit according to the invention consists of the kit components A and B as disclosed herein and written instructions, pictograms or other readable forms of instructions in the form of barcodes or QR-codes.

Examples of separate primary packages packaged together within one secondary package include but are not limited to one sachet, stickpack, foil or plastic bag, or filled straw for each kit-component; the two or more separate primary packages then being packaged together into e.g. a cardboard box (or other suited outer packaging). Alternatively, a vial, ampoule or bottle may be packaged together with a sachet, or stickpack, foil or plastic bag, or filled straw; or both kit components may be in vials, ampoules or bottles; or one component may be provided in a sachet, stickpack foil or plastic bag, or filled straw, while the other is provided in the form of a foil-wrapped snack-bar, etc.. Again, multiples of these primary packages may be packed together in the secondary package, e.g. multiples of 7 for a ‘week-pack’ (if administration of both components is once daily); or multiples of 28 (or 31) for a ‘monthly pack’.

In one embodiment, the kit comprises component A provided in a bottle, sachet, stickpack foil or plastic bag, while component B is provided in a filled straw, e.g. in a filled straw such as suggested in U.S. Pat. No. 1,254,115 A. The straw described in U.S. Pat. No. 1,254,115 A serves both as a container and a drinking straw, and its contents are typically emptied from the straw into either a glass of ingestible liquid or into the bottle housing component A (or the liquid is added to said glass or bottle after emptying the straw), stirred to form a drink formulation, and then optionally consumed through the straw. The straw may be closed on both end e.g. by sealing foils, plugs or hard gelatine capsule ends.

In a specific embodiment, component A is provided in a bottle leaving enough empty volume to add an ingestible liquid, e.g. water or milk, in an amount needed to prepare a drink suspension which may then be readily consumed from said bottle; and component B comprises one or more flavourants and is provided in a filled straw which may optionally be added from the straw to the bottle of component A prior to consumption. Providing the flavourant(s) in a separate primary package allows the user, or consumer, to choose the taste they like best and in the amount they like best.

Optionally, the bottle may have a fill indication, such as an engraved or imprinted fill line or similar visible markings; this facilitates the preparation of the drink suspension in that the consumer is intuitively guided how much fluid is to be added into the bottle. If opaque labels or wrappings are used on, or around, the bottle (e.g. to print nutritional information and/or use instructions thereon), a transparent “window” may be provided at the position of the fill indication. In one embodiment, the bottles have a volume of about 100 to about 200 mL. e.g. 150 mL, and is supposed to be filled with about 60 to about 100 mL ingestible liquid, e.g. about 80 mL (up to the fill indication); like this, enough air volume is left in the closed bottle to shake vigorously and form a drink suspension.

Instead of being provided in the same secondary package, as described above, the primary packages may also be packaged in different separate secondary packages which are in turn held together by paper or plastic wrappers in order to show their ‘kit character’. Examples include but are not limited to two separate sets of sachets for two kit components, the two sachet-sets being sold in two card-board boxes, the latter being wrapped with a shrink foil wrapper.

Alternatively, combinations of the above may be provided; e.g. a first kit-component being provided in multiple-dose card-board drum as a primary package (optionally with a dosing spoon), the card-board drum being sold in a folded box together with a multitude of foil-wrapped single-dose units, or single dose packages, of a second kit-component; or the card-board drum being sold together with a folded box containing a multitude of foil-wrapped single-dose units, with the drum and the box being connected with a wrapper.

In one embodiment, component A is provided in a multiple-dose container, optionally equipped with a dosing tool, or in one or more single dose units, or single dose packages; and component B is provided in one or more single dose units, or single dose packages; wherein the single dose unit, or single dose package is selected from vials, ampoules, bottles, sachets, stickpacks, foil or plastic bags, or filled straws, or their respective compartments.

For instance, in a specific embodiment, component A is provided in a first vial, ampoule or bottle; preferably equipped with a cap housing a reservoir separated from, and optionally connectable to, the inner volume of said first vial, ampoule or bottle; and component B is provided in said cap reservoir, or in a sachet, stickpack, foil or plastic bag, or in a filled straw, or in a second vial, ampoule or bottle.

In a further embodiment, component A is provided in a first vial, ampoule or bottle, equipped with a cap housing a reservoir separated from, and optionally connectable to, the inner volume of said first vial, ampoule or bottle; component B is provided in a second vial, ampoule or bottle; and/or component B′ in the form of an oil, comprising an unsaturated fatty acid compound, a vitamin, or combinations thereof, is provided in said cap reservoir.

Alternatively, component A is provided in a first vial, ampoule or bottle, equipped with a cap housing a reservoir separated from, and optionally connectable to, the inner volume of said first vial, ampoule or bottle; component B is provided in a sachet, stickpack, foil or plastic bags, or filled straw; and/or component B′ in the form of an oil, comprising an unsaturated fatty acid compound, a vitamin, or combinations thereof, is provided in said cap reservoir or in a filled straw.

Optionally, the kit may further contain written instructions, pictograms or other readable forms of instructions (e.g. barcodes, QR-codes) to the consumer concerning recommendations as to the manner of oral consumption of component A and/or component B; e.g. if and how one or all kit components should be mixed with either each other and/or ingestible liquids or semisolids (e.g. water, milk, juice, yoghurt); or how many times a day one or all kit components should be consumed.

In that regard, it should be noted, that the fact of providing and selling at least two kit components A and B together in an obvious and intentional combination, a kit, does not necessarily imply, that the two should be ingested at the very same time. For instance, the granulate of component A may be used as a meal replacement, whereas a snack-bar of component B may be intended for ‘in between meals’. In contrast, where component B is an oil comprising an unsaturated fatty acid compound (e.g. an unsaturated fatty acid ester) and/or a vitamin stored in a dosing cap or in a filled straw, it may be intended for the consumer to empty said dosing cap's or filled straw's contents into the bottle holding component A, in order for the two to be consumed together. In other words, the kit merely has the purpose to provide two components in combination—at least one of them being a satiety inducing component suited and intended to substitute, or replace, a meal fully or partially—which supplement and/or support each other in their satiety inducing effect or which are otherwise considered beneficial in this combination. For instance, in the above examples, the snack-bar as component B may provide a healthier and more satiating choice for the consumer when he/she feels hungry in between meals, making it easier to stick to a dieting schedule involving component A, e.g. in granulate form, as a meal replacement. A balanced blend of proteins, amino acids, vitamins and micro-nutrients, dietary elements and/or dietary fibres as component B may support diet schedule adherence of consumers who worry about their nutrient intake during a diet schedule.

In a further aspect, the kits may optionally be personalised, or customised; i.e. the two or more kit components may be selected from a wider range of options, according to e.g. the dietary preference of a specific consumer and/or recommendations by e.g. a dietitian or medical staff. Exemplary selections for personalisation, or customisation, may be made with regard to taste preferences (such as sweet vs. hearty), with regard to the preferred form of component A and/or B (e.g. granulate+flakes vs. pellets+snack-bar, or the like), with regard to a consumer's allergy requirements (e.g. snack-bars with or without nuts, or a granulate with or without specific sweeteners, with or without lactose, etc.), and/or with regard to the consumer's needs for nutrient supplementation (e.g. if the consumer is diagnosed to run low on vitamins a combination of granulate component A with a vitamin-enriched oil as component B may be more suited than a satiety inducing snack-bar).

In a further aspect, the invention provides the kit described in this invention for use in:
a) the prevention and/or treatment of obesity or a disease or condition associated with obesity,
b) appetite suppression,
c) induction and/or prolongation of satiety, and/or
d) body weight reduction;

wherein the use optionally comprises the oral administration of at least component A at a frequency of at least once a day over a period of at least one week, and wherein optionally the oral administration of at least component A may be used as a full or partial meal replacement.

It is not compulsory, though, to replace meals fully or in parts using component A. For instance, instead of replacing e.g. a full lunch or instead of replacing just the dessert with component A, consumers may also decide to simply add component A, in particular the ingestible particles of component A, to their usual foods in order to feel satiated for a longer time period and thus eating less in their subsequent meal and/or delaying it. As described above, component B in the kits supports the prevention and/or treatment of obesity, appetite suppression and body weight reduction, e.g. in that it increases compliance of the consumers and increases safety of consumers with respect to meeting a consumer's dietary needs even during weight loss regimens. In other words, while both components A and B may be used separately and independently of one another in the treatment and/or prevention of obesity (or associated diseases or conditions), for appetite suppression, body weight reduction, and/or for induction and/or prolongation of satiety, the best results are achieved by their combined use. A kit of the two, optionally together with written instructions, thus represents one of the preferred embodiments of the invention.

The invention provides the use of the kit described in this invention in, or for;
e) the prevention and/or treatment of obesity or a disease or condition associated with obesity,
f) appetite suppression,
g) induction and/or prolongation of satiety, and/or
h) body weight reduction;

wherein the use optionally comprises the oral administration of at least component A at a frequency of at least once a day over a period of at least one week, and wherein optionally the oral administration of at least component A may be used as a full or partial meal replacement.

The invention further provides a use of a component A in combination with a component B, in, or for:
i) the prevention and/or treatment of obesity or a disease or condition associated with obesity,
j) appetite suppression,
k) induction and/or prolongation of satiety, and/or
l) body weight reduction;

wherein the use optionally comprises the oral administration of at least component A at a frequency of at least once a day over a period of at least one week, and wherein optionally the oral administration of at least component A may be used as a full or partial meal replacement, and wherein

component A comprises a first ingestible solid formulation comprising a first intimate mixture of a first lipid material comprising a medium or long chain fatty acid compound and a first water-swellable or water-soluble polymer, wherein the first ingestible solid formulation is provided in form of ingestible particles having a sieve diameter in the range from 0.01 mm to 10 mm, or from 0.05 mm to 3 mm; and wherein

component B is selected from
an oil comprising an unsaturated fatty acid compound, a vitamin, or combinations thereof;
a powder, or powder-blend, comprising a protein, a vitamin, a micro-nutrient, a dietary element, a dietary fibre, an amino acid or combinations thereof,
a granulate comprising a protein, a vitamin, a micro-nutrient, a dietary element, a dietary fibre, an amino acid or combinations thereof,
a powder, powder-blend or granulate comprising a flavourant, and/or
a second ingestible solid formulation comprising a second intimate mixture of a second lipid material comprising a medium or long chain fatty acid compound and a second water-swellable or water-soluble polymer, wherein the second ingestible solid formulation is different from the first ingestible solid formulation; and wherein

kit components A and B are supplied in:
separate compartments of one primary package,
separate primary packages packaged together within one secondary package,
separate primary packages packaged in two or more separate secondary packages which are in turn held together by paper or plastic wrappers, ribbons, sleeves or the like, or
combinations thereof.

Diseases or conditions associated with obesity include for instance hyperlipidemia, diabetes, heart disease, stroke, gall bladder disease, gout, sleep apnoea, etc.. It is currently evaluated whether the use of the kit, i.e. the combined use of components A and B as described herein, is effective in treating and/or preventing these diseases directly; or whether the positive effects observed in small numbers of consumers are achieved predominantly via treating and/or preventing said diseases' root-cause, namely obesity.

Any of the features described earlier for the kit components A and B as such, apply equally to their combined use in the form of kits; e.g. any features on the nature and the amounts of the lipid materials and/or the water-swellable or water-soluble polymers in the solid ingestible formulations of component A and/or B.

### EXAMPLES

Various examples on compositions and preparation methods for the first and/or second ingestible solid formulations according to the invention maybe found in previous applications of the inventor which are incorporated herein by reference; in particular application PCT/EP2015/068501 or EP15175571.7 for the ingestible solid formulations in kit component A; as well as the application EP15180659.3 or EP15202552.4 for the ingestible solid formulations in kit component B. Further examples are provided below.

### Example 1

A granulate premix is prepared by filling 12.5 kg glycerol monolaurate (GML 90 food, Mosselman, Belgium), 8.33 kg glycerol monooleate (Imwitor® 990, Nordmann Rassmann GmbH, Germany) and 12.5 kg triglyceride-based hard fat 1 (Witepsol® E85, Nordmann Rassmann GmbH, Germany) into the mixing chamber of a granulation device (F130D, Gebrüder Lödige Maschinenbau GmbH, Germany). The chamber is heated using an external temperature control system (Compact TKN-90-18-35, Single Temperiertechnik GmbH, Germany) with the mixing tool running at 30 rpm. After the lipid components are brought to a homogeneous melt at 60° C., 15.83 kg HPMC (AnyAddy® CN10T, Harke Pharma GmbH, Germany) and 0.83 kg Xanthan (Nordmann Rassmann GmbH, Germany) are added and blended at 40 rpm until homogeneity. Then, the heating system is turned off and 12 kg of dry ice is rapidly introduced into the mixing chamber with the mixer running at 40 rpm. Subsequently, the milling head is activated and the granulate premix is obtained, released through the outlet and collected in bags.

The obtained granulate premix is then fed via a volumetric dosing system (Dosimex® DO-50, Gabler GmbH & Co KG, Germany) into the powder inlet of a twin screw extruder (Extruder DE-40/10, Gabler GmbH & Co KG, Germany; operating at 14 rpm) and extruded at a temperature range of about 18° C. to strands of 1.0 mm diameter. Extruded strands are cut to granules of 0.8-2.5 mm length by means of rotating blades (running at 300 rpm).

The resulting granulate may be used in the kit as component A; optionally after blending it with a powder, powder blend or granulate comprising a protein (e.g. protein-enriched whey powder, or a soy protein, milk protein or pea protein, or isolates and/or concentrates thereof) and/or a thickening agent (e.g. carboxymethylcellulose, in particular sodium-CMC, xanthan gum or guar gum). Further optionally, the resulting granulate may be processed further and receive a top-coating as detailed in example 2 below or in example 16 below. This is considered useful since the top-coating allows for convenient oral administration without the water-swellable or water-soluble polymer interacting with, or sticking to, the mucosa of the mouth or oesophagus during ingestion,

### Example 2

The extrudates obtained from example 1 or 15 are classified on a sieving machine (Siftomat® 1, Fuchs Maschinen AG, Switzerland) to collect granules having a sieve diameter of 1-2 mm. An amount of 45 kg of the resulting material is loaded into a fluid bed device (Ventilus® V-100, Innojet, Germany) and fluidized at a bed temperature of 15° C. at an air flow of 1000 cm³/h. An amount of 9 kg hard fat (Dynasan® 116, Cremer Oleo GmbH & Co KG, Germany) is molten in an external heating system and the hot melt quantitatively sprayed onto the granulate using hot melt top spraying system at a pressure of 1.2 bar and a spray rate of 300 g/min.

The coated granulate is obtained and stored in a plastic container. It may be used in the kit as component A; optionally after blending the coated granulate with a powder, powder blend or granulate comprising a protein (e.g. protein-enriched whey powder, or a soy protein, milk protein or pea protein or isolates and/or concentrates thereof) and/or a thickening agent (e.g. carboxymethylcellulose, in particular sodium-CMC, xanthan gum or guar gum).

### Example 3

An amount of 14 kg granulate premix is prepared in seven batches of 2 kg each. For each batch, 0.9 kg palm stearin (Prifex® 300, Brenntag B.V. Belgium) and 0.1 kg linseed oil (manako BIO Leinol human, Makana, Germany) are brought to a melt in a cooking pot over an induction plate. When the melt has a temperature of 60° C., 0.3 kg sodium alginate (Satinex®, Kimica, Japan), 0.1 kg oat fibre preparation (PromOat®, Harke Pharma, Germany; containing beta-glucan), 0.5 kg resistant dextrin (Nutriose®, Roquette, France) and 0.1 kg pectin (Aglupectin® HS-RVP, Nordmann Rassmann GmbH, Germany) are incorporated by means of a cooking spoon.

The mixture is transferred in aliquots into zip-loc plastic bags and cooled to room temperature to form solid plates. The solidified lipid-polymer plates are further cooled in a freezer set at −18° C. and then shredded to particles of about 5 mm and smaller by means of a blender (Vitamix® Professional 750, Vita-Mix Corp., USA).

The obtained premix is fed via a volumetric dosing system (Dosimex® DO-50, Gabler, Germany) into a powder inlet of a twin screw extruder (Extruder DE-40/10, Gabler, Germany, operating at 10 rpm) and extruded at a temperature range of about 30° C. to strands of 1.0 mm diameter. Extruded strands are cut to granules of 0.8-2.5 mm length by means of rotating blades (running at 100 rpm). The extrudate is transferred into plastic bags in aliquots and stored at −18° C.

The resulting granulate may be used in the kit as component A; optionally after blending it with a powder, powder blend or granulate comprising a protein (e.g. protein-enriched whey powder, or a soy protein, milk protein or pea protein, or isolates and/or concentrates thereof) and/or a thickening agent (e.g. carboxymethylcellulose, in particular sodium-CMC, xanthan gum or guar gum). Further optionally, the resulting granulate may be processed further and receive a top-coating as detailed in example 4 below.

### Example 4

The granules obtained from example 3 are subjected to classification using wire mesh sieves (Atechnik GmbH, Germany) of 2 mm (mesh 10) and 1.0 mm (mesh 18). Material retained on the 2 mm sieve is subjected to comminution using a household blending device (MK55300, Siemens, Germany) and then re-classified using the same wire mesh sieves.

Granules classified to a sieve diameter range of 1-2 mm are combined to give a yield of 9.0 kg and split into aliquots of 600 g. Batches (one aliquot per run, fifteen runs in total) are loaded into a fluid bed device (Ventilus® V-2.5/1, Innojet, Germany, equipped with an IPC3 product reservoir) and fluidized at a bed temperature of 20° C. at an air flow of 65 cm³/h. Per run, 120 g palm stearin (Prifex® 300, Brenntag N.V., Belgium) are molten in a beaker on a hot plate (set at 100° C.) equipped with an overhead stirrer. The hot melt is quantitatively sprayed onto the granulate using a peristaltic pump and a top spraying procedure at a spray rate of 6.5 g/min. Batches are combined, and a total of 10.67 kg of coated granulate was obtained and stored in a plastic container.

The coated granulate may be used in the kit as component A; optionally after blending the coated granulate with a powder, powder blend or granulate comprising a protein (e.g. protein-enriched whey powder, or a soy protein, milk protein or pea protein, or isolates and/or concentrates thereof) and/or a thickening agent (e.g. carboxymethylcellulose, in particular sodium-CMC, xanthan gum or guar gum).

### Example 5

The above listed (coated) granulates of examples 1 to 4 are packaged in glass vials, or bottles. Twenty-eight 38 mm screw cap with built-in dosage cap (e.g. as obtainable from Fostag Formenbau AG, Switzerland) are filled with

5.1 safflower seed oil (Mosselman, Belgium),

5.2 grape seed oil (Mosselman, Belgium),

5.3 linseed oil/flaxseed oil (Mosselman, Belgium),

5.4 walnut oil (Mosselman, Belgium),

5.5 rape seed oil (Mosselman, Belgium),

5.6 hemp seed oil (Naissance, Germany)

5.7 fish oil 18/12 (Mosselman, Belgium),

After the filling step, the dosage cap is heat-sealed by means of an aluminium foil equipped with a heat sensitive polymer layer and subsequently screwed onto the glass bottles with the (coated) granulates of examples 1 to 4 in order to form kits. Optionally, multiples of 7 and/or multiples of 28 (or 31) of these kits may further be packaged in a card-board box together with written instructions, pictograms or other readable forms of instructions (e.g. barcodes, QR-codes) concerning the oral administration to the human subject.

### Example 6

In analogy to example 5, the oils (5.1-5.7) are filled into sachets, stickpacks, foil or plastic bags, or filled straws, and the sachets, stickpacks, foil or plastic bags, or filled straws are heat-sealed or otherwise closed. The glass bottles with the (coated) granulates of examples 1 to 4 and the sachets, stickpacks, foil or plastic bags, or filled straws are wrapped together, one of each, with a thin foil wrapper to form a kit. Optionally, multiples of 7 and/or multiples of 28 (or 31) of these foil-wrapped kits may further be packaged in a card-board box together with written instructions, pictograms or other readable forms of instructions (e.g. barcodes, QR-codes) concerning the oral administration to the human subject.

### Example 7

In analogy to example 5, the oils (5.1-5.2 and 5.5-5.7) are provided in the form of oil powders (65-67% oil on a tapioca-maltodextrin carrier; obtained from Bressmer & Francke, Germany) and filled into sachets, stickpacks, foil or plastic bags, or filled straws, and the sachets, stickpacks, foil or plastic bags, or filled straws are heat-sealed or otherwise closed. The glass bottles with the (coated) granulates of examples 1 to 4 and the sachets, stickpacks, foil or plastic bags, or filled straws are wrapped together, one of each, with a thin foil wrapper to form a kit. Optionally, multiples of 7 and/or multiples of 28 (or 31) of these foil-wrapped kits may further be packaged in a card-board box together with written instructions, pictograms or other readable forms of instructions (e.g. barcodes, QR-codes) concerning the oral administration to the human subject.

### Example 8

The above listed (coated) granulates of examples 1 to 4 are packaged in glass vials, or bottles. Four 38 mm screw cap with built-in dosage cap (e.g. as obtainable from Fostag Formenbau AG, Switzerland) are filled with an exemplary powder mixture comprising: orange flavour(or other flavours, such as chocolate, vanilla, berry, etc.), maltodextrin, sodium cyclamate, sodium saccharin, magnesium hydroxide; as well as a blend of vitamins and micro-nutrients comprising: L-ascorbic acid, DL-a-tocopherylacetate, nicotinamide, calcium-D-pantothenate, manganese sulphate, cholecalciferol, zinc oxide, ferric pyrophosphate, cupric carbonate, pyridoxine hydrochloride, riboflavin, thiamine mononitrate, retinyl acetate, folic acid, sodium selenite, sodium iodide, D-biotin and cyanocobalamin.

After a heat-sealing step, each dosage cap is fitted on top of one of the glass bottles with the (coated) granulates of examples 1 to 4 to form a kit. Optionally, multiples of 7 and/or multiples of 28 (or 31) of these kits may further be packaged in a card-board box together with written instructions, pictograms or other readable forms of instructions (e.g. barcodes, QR-codes) concerning the oral administration to the human subject.

### Example 9

The above listed (coated) granulates of examples 1 to 4 are filled into sachets, stickpacks, foil or plastic bags, or filled straws, and the sachets, stickpacks, foil or plastic bags, or filled straws, are heat-sealed or otherwise closed. The same is done with an exemplary powder mixture comprising: about 55% protein enriched whey powder, milk protein, soy protein isolate, wheat protein, low-fat cocoa powder, carboxymethylcellulose, caramel sugar, ferric pyrophosphate, silicon dioxide, zinc oxide; as well as the blend of vitamins and micro-nutrients as in Example 8.

The sachets with the protein-vitamin-micronutrient powder mixture and the sachets with the (coated) granulates of examples 1 to 4 are packed—in multiples of 7 and/or 28 (or 31) of each sachet—into e.g. cardboard boxes, equipped with a cardboard divider to prevent mixing of the two sets of sachets during shipping and storage. The cardboard boxes may comprise written instructions, pictograms or other readable forms of instructions (e.g. barcodes, QR-codes) concerning the oral administration to the human subject printed on the outside of the box.

In an alternative approach, the (coated) granulates of examples 1 to 4 are filled into the first compartment of a side-by-side double-pouch sachet; and the protein-vitamin-micronutrient powder mixture is filled into the second compartment. The laminated seam separating the first from the second compartment is equipped with a perforated line, such that the two may optionally be split, or separated, by the human subject without thereby opening the compartments.

### Example 10

A premix is prepared by melting 100 g palm stearin (Prifex® 300; Unimills, The Netherlands) at 60-80° C. to obtain a homogeneous melt. First, 50 g of soy protein (Unisol® DP IP non GMO; Barentz, The Netherlands) are added, followed by 50 g of a resistant dextrin (Nutriose®; Roquette, France), both being incorporated by mechanical mixing and without further heating. The composition is transferred into a zip-loc-bag, formed into a spread, or cast sheet, of about 1-5 mm thickness and then cooled to −18° C. in a freezer. Just prior to further processing, the spread, or cast sheet, was removed from the freezer and brought to room temperature.

The resulting premix may optionally be extruded into granules of about 1 mm diameter and about 0.8-2.5 mm length, e.g. using the processes described in examples 1 or 3. The resulting granulate may be used in the kit as component B.

Alternatively, the premix may be formulated as flakes, ‘crunchier’ or snack-bars, as will be detailed in Examples 12 to 14 below.

### Example 11

A premix is prepared by melting 70 g palm stearin (Prifex® 300; Unimills, The Netherlands) at 60-80° C. to obtain a homogeneous melt. First, 70 g of soy protein (Unisol® DP IP non GMO; Barentz, The Netherlands) are added, followed by 50 g of a resistant dextrin (Nutriose®; Roquette, France) and 20 g of safflower oil (Mosselman, Belgium) all being incorporated by mechanical mixing and without further heating. The composition is transferred into a zip-loc-bag, formed into a spread, or cast sheet, of about 1-5 mm thickness and then cooled to −18° C. in a freezer. Just prior to further processing, the spread, or cast sheet is removed from the freezer and brought to room temperature.

### Example 12

Spreads, or cast sheets, of the premixes of examples 10 and 11 were removed from the freezer and allowed to warm to room temperature. Then the cast sheet is carefully cut into rectangular flakes of about 5 mm by 7 mm, and with a thickness of about 1-5 mm, typically about 1-3 mm.

Said flakes may form component B as such, or they may further be blended gently with other comestible materials. For instance, 20 g of the flakes are mixed into a cereal mixture comprising 22 g of soy crispies (KUK, Germany), 12 g of spelt flakes (Spielberger, Germany) and 8 g freeze-dried raspberries (Tali, Germany) to form component B of the kit. About 60 g of the ‘muesli-flakes-blend’ is packaged into a foil bag (alternatively a plastic bag) and connected e.g. to a bottle comprising the coated granulate of example 4 with a small foil wrapper to form a kit. Again, multiples of 7 and/or 28 (or 31) may optionally be packaged in a cardboard box (or other suited outer packaging) together with written instructions, pictograms or other readable forms of instructions (e.g. barcodes, QR-codes) concerning the oral administration to the human subject.

### Example 13

Spreads, or cast sheets, of the premix of example 10 was removed from the freezer and allowed to warm to room temperature. About 25 g are broken into pieces and molten again at 60-80° C. About 25 g spelt flakes (Korngabe, Germany) were gently crushed to about 5-6 mm pieces and added, together with 25 g soy crispies (KUK, Germany), to the melt and thoroughly mixed without further heating. Then 25 g rice syrup (Werz, Germany) are added and mixed in. Optionally, 30 g cranberries (Kaufland, Germany) are cut to pieces of 2-5 mm and incorporated into the mixture, which then was spread out on a baking tray to form a layer of about 10 mm thickness on average. The spread was baked at about 120° C. for about 20 min in a conventional oven using hot air convection. After cooling to room temperature, the baked spread was broken into pieces of about 10 mm size. These pieces may be referred to as ‘crunchier’.

About 60 g of ‘crunchier’ are packaged into a foil bag (alternatively a plastic bag) and connected e.g. to a bottle comprising the coated granulate of example 4 with a small foil wrapper to form a kit. Again, multiples of 7 and/or 28 (or 31) may optionally be packaged in a cardboard (or other suited outer packaging) box together with written instructions, pictograms or other readable forms of instructions (e.g. barcodes, QR-codes) concerning the oral administration to the human subject.

### Example 14

Alternatively, instead of preparing ‘crunchier’, the mixture described in Example 13 may also be transferred into moulds of snack-bar size (in this example about 90 mm×20 mm×12 mm), baked at about 120° C. for about 20 min in a conventional oven using hot air convection and removed from the moulds once cooled down. One bar packaged in a foil bag and connected e.g. to a bottle comprising the coated granulate of example 4 with a small foil wrapper to form a kit. Again, multiples of 7 and/or 28 (or 31) may optionally be packaged in a cardboard box (or other suited outer packaging) together with written instructions, pictograms or other readable forms of instructions (e.g. barcodes, QR-codes) concerning the oral administration to the human subject.

### Example 15

An alternative granulate premix to Example 1 is prepared by filling 3.22 kg glycerol monostearate (GMS 90 food, Mosselman, Belgium), 5.37 kg glycerol monooleate (Imwitor® 990, Nordmann Rassmann GmbH, Germany), 9.98 kg triglyceride-based hard fat 1 (Witepsol® E85, Nordmann Rassmann GmbH, Germany) and 5.37 kg triglyceride-based hard fat 2 (Witepsol® W25, Nordmann Rassmann GmbH, Germany) into the mixing chamber of a granulation device (F130D, Gebrüder Lödige Maschinenbau GmbH, Germany). The chamber is heated using an external temperature control system (Compact TKN-90-18-35, Single Temperiertechnik GmbH, Germany) with the mixing tool running at 40 rpm. After the lipid components are brought to a homogeneous melt at 70° C., 15.35 kg HPMC (AnyAddy® CN10T, Harke Pharma GmbH, Germany) and 10.71 kg sodium stearate (sodium stearate EP 7.0, Mosselman, Belgium) are added and blended at 40 rpm until homogeneity. Then, the heating system is turned off and 15 kg of dry ice is rapidly introduced into the mixing chamber with the mixer running at 50 rpm. Subsequently, the milling head is activated and the granulate premix is obtained, released through the outlet and collected in bags.

The obtained granulate premix is then fed via a volumetric dosing system (Dosimex® DO-50, Gabler GmbH & Co KG, Germany) into the powder inlet of a twin screw extruder (Extruder DE-40/10, Gabler GmbH & Co KG, Germany; operating at 35 rpm) and extruded at a temperature range of about 33° C. to strands of 1.0 mm diameter. Extruded strands are filled into the mixing chamber of a granulation device (F130D, Gebrüder Lödige Maschinenbau GmbH, Germany) and cut to granules. First the mixer is running at 40 rpm for 45 s. Subsequently, 0.5 kg dry ice is added and the milling head is activated for 10 min to obtain granules of 0.8-2.5 mm length.

The resulting granulate may be used in the kit as component A; optionally after blending it with a powder, powder blend or granulate comprising a protein (e.g. protein-enriched whey powder, or a soy protein, milk protein or pea protein, or isolates and/or concentrates thereof) and/or a thickening agent (e.g. carboxymethylcellulose, in particular sodium-CMC, xanthan gum or guar gum). Further optionally, the resulting granulate may be processed further and receive a top-coating as detailed in example 2 above or in example 16 below.

### Example 16

The extrudates obtained from examples 1 or 15 are classified on a sieving machine (Siftomat® 1, Fuchs Maschinen AG, Switzerland) to collect granules having a sieve diameter of 1-2 mm. An amount of 45 kg of the resulting material is loaded into a fluid bed device (GPCG 15, bottom-spray with 18′ Wurster-insert, Glatt GmbH, Germany) and fluidized at a bed temperature of 22° C. at an air flow of 650-750 m³/h. An amount of 6.75 kg glycerol monostearate (GMS 90 food, Mosselman, Belgium) is molten in an external heating system and the hot melt quantitatively sprayed onto the granulate using hot melt top spraying system at a pressure of 1.5-2.0 bar and a spray rate of 105-180 g/min.

The coated granulate is obtained and stored in a plastic container. It may be used in the kit as component A; optionally after blending the coated granulate with a powder, powder blend or granulate comprising a protein (e.g. a soy protein, milk protein or pea protein, or isolates and/or concentrates thereof) and/or a thickening agent (e.g. carboxymethylcellulose in particular sodium-CMC, xanthan gum or guar gum).

### Example 17

Between about 10 g and 20 g of the coated granules obtained from example 16, e.g. about 14 g or about 15 g, are used in the kit as component A, together with a drink powder blend. For this purpose, the particles are filled into a bottle (e.g. a plastic bottle with about 100-250 mL volume and a fill indication), which further contains about 13 g to about 14 g of an exemplary drink powder mixture comprising: protein enriched whey powder, milk protein, soy protein isolate, wheat protein; wheat-derived dextrin, psyllium seed husk (finely ground), sodium carboxymethylcellulose and xanthan gum as thickening agents; maltodextrin, sunflower lecithin, magnesium hydroxide, silicon dioxide; as well as a blend of vitamins and micro-nutrients, e.g. the blend shown in Example 8. In this example, the bottle has a volume of 150 mL and is supposed to be filled with about 80 mL ingestible liquid (up to the fill indication); like this, enough air volume is left in the closed bottle to shake vigorously and form the drink suspension.

Component B of the kit may be the flakes of Example 12; for instance, 20 g of the flakes mixed into cereal mixtures, and about 60 g of the ‘muesli-flakes-blend’ then packaged into a foil or plastic bag. These bags are connected to the bottles comprising the coated granulate of example 16 with a small foil wrapper to form a kit. Multiples of 7 and/or 28 (or 31) may optionally be packaged in a cardboard box (or alternative suited outer packaging) together with written instructions, pictograms or other readable forms of instructions (e.g. barcodes, QR-codes) concerning the oral administration to the human subject. Like this the consumer can, for instance, prepare and consume the muesli-flakes blend of component B in the morning, and consume the drink suspension of component A together with, or instead of, his/her lunch time or diner time meal.

Alternatively, a snack bar such as described in Example 14 may be provided as component B, combined with the above described bottles comprising the coated granulate of example 16 as component A. Like this the consumer can, for instance, prepare and consume the drink suspension in the morning, and take the snack-bar to work, e.g. to avoid unhealthy ‘snacking’ during the afternoon.

Further alternatively, component B of the kit may be packaged and provided in sachets, stick packs, foil or plastic bags, or filled straws; and may for instance comprise blends of various flavourants; such as a chocolate flavour blend with caramel sugar, low-fat cocoa, sodium cyclamate or sodium saccharin. Of course, other flavour options are available, such as vanilla flavour, berry flavour etc., and may be provided as component B. Besides different flavours, the constituents may also take into consideration special dietary requirements of the consumer, e.g. flavourant blends which are sugar-free for diabetic consumers, or free of artificial sweeteners and/or lactose for consumers with food related allergies or intolerances.

Based on the consumer's selection, a customized kit is then provided which includes the bottle containing kit component A (i.e. the ingestible particles as well as a powder blend comprising proteins and/or thickeners as described; the powder blend optionally being in granulated form) and sachets, stick packs, foil or plastic bags, or filled straws containing selected component B are packed—in multiples of 7 and/or 28 (or 31) of each bottle—into e.g. cardboard boxes. The cardboard boxes may comprise written instructions, pictograms or other readable forms of instructions (e.g. barcodes, QR-codes) concerning the oral administration to the human subject printed on the outside of the box.

1. A kit comprising a component A in combination with a component B, wherein
component A comprises a first ingestible solid formulation comprising a first intimate mixture of a first lipid material comprising a medium or long chain fatty acid compound and a first water-swellable or water-soluble polymer, wherein the first ingestible solid formulation is provided in form of ingestible particles having a sieve diameter in the range from 0.01 mm to 10 mm, or from 0.05 mm to 3 mm; and wherein
component B is selected from
an oil comprising an unsaturated fatty acid compound, a vitamin, or combinations thereof;
a powder, or powder-blend, comprising a protein, a vitamin, a micro-nutrient, a dietary element, a dietary fibre, an amino acid or combinations thereof,
a granulate comprising a protein, a vitamin, a micro-nutrient, a dietary element, a dietary fibre, an amino acid or combinations thereof,
a powder, powder-blend or granulate comprising a flavourant, and/or
a second ingestible solid formulation comprising a second intimate mixture of a second lipid material comprising a medium or long chain fatty acid compound and a second water-swellable or water-soluble polymer, wherein the second ingestible solid formulation is different from the first ingestible solid formulation; and wherein
kit components A and B are supplied in:
separate compartments of one primary package,
separate primary packages packaged together within one secondary package,
separate primary packages packaged in two or more separate secondary packages which are in turn held together by paper or plastic wrappers, ribbons, sleeves or the like, or
combinations thereof.

2. The kit of claim 1, wherein the ingestible particles in component A are provided in the form of
granules, pellets and/or minitablets having a sieve diameter in the range from 0.05 mm to 3 mm, and/or
flakes, shavings, chips and/or sprinkles having a sieve diameter in the range from 0.01 mm to 10 mm, preferably 1 mm to 10 mm.

3. The kit of claim 1, wherein the second ingestible solid formulation in component B is provided in the form of
granules, pellets and/or minitablets having a sieve diameter in the range from 0.05 mm to 3 mm,
flakes, shavings, chips and/or sprinkles having a sieve diameter in the range from 0.01 mm to 10 mm; or
a non-particulate matrix, such as in the form of a snack-bar comprising the second intimate mixture and optionally a further comestible material, or
the second intimate mixture forming a layer on a further comestible material, such as cereal flakes, soy puffs or rice puffs.

4. The kit of claim 1, wherein the first ingestible solid formulation and/or the second ingestible solid formulation is provided in the form of granules, pellets and/or minitablets having a sieve diameter in the range from 0.05 mm to 3 mm, wherein said granules, pellets and/or minitablets comprise
an active core comprising the first and/or second lipid material and the first and/or second water-swellable or water-soluble polymer in the form of the first and/or second intimate mixture, or
an inert starter core coated with an active coating of the first and/or second intimate mixture comprising the first and/or second lipid material and the first and/or second water-swellable or water-soluble polymer,
and wherein
the granules, pellets and/or minitablets optionally comprise a top-coating comprising a third lipid material, wherein said top-coating may be substantially free of the first and/or second water-swellable or water-soluble polymer, and wherein the third lipid material may be the same as, or different from, the first and/or second lipid material.

5. The kit of claim 1, wherein
the first and/or second lipid material comprises a medium or long chain fatty acid compound exhibiting a melting point of higher than 37° C., or from 38° C. to 75° C., or from 40° C. to 70° C.; and
the first and/or second water-swellable or water-soluble polymer is selected from:
(a) cellulose ethers, pectins, alginic acid, poly(acrylic acid), poly(methacrylic acid), copolymers of acrylic and methacrylic acid, poly(hydroxyethyl methacrylic acid), chitosan, gellan gum, guar gum, xanthan gum and gum arabic, or respective salts thereof, or
(b) water-soluble polysaccharides based on glucose or fructose having an average degree of polymerisation from 2 to 100, or from 4 to 80 and being resistant to digestion in the human small intestine.

6. The kit of claim 1, wherein
each of the first and the second ingestible solid formulation comprises at least 40%, or at least 45%, or at least 50% of the first or second lipid material, respectively, and at least 10%, or at least 20%, or at least 30% of the first or second water-swellable or water-soluble polymer, respectively; and/or wherein
each of the first and the second intimate mixture comprises at least 40%, at least 45%, or at least 50% of the first or second lipid material, respectively, and at least 10%, or at least 20%, or at least 30% of the first or second water-swellable or water-soluble polymer, respectively.

7. The kit of claim 1, wherein
the first lipid material comprises a triglyceride, a blend of partial fatty acid glycerides, and/or a blend of a triglyceride with a partial fatty acid glyceride; and wherein
the first water-swellable or water-soluble polymer comprises a cellulose ether, an alginate, a pectin and/or a xanthan.

8. The kit of claim 7, wherein the first lipid material comprises a blend of glycerol monolaurate (GML) and glycerol monooleate (GMO), and wherein the cellulose ether is selected from hydroxyethyl cellulose, hydroxypropyl cellulose, hydroxypropyl methylcellulose, methylcellulose, and carboxymethylcellulose; preferably hydroxypropyl methylcellulose.

9. The kit of claim 7, wherein the first lipid material in the first intimate mixture comprises a blend of glycerol monostearate (GMS), glycerolmonooleate (GMO), a triglyceride-based hard fat (Adeps solidus); and wherein the cellulose ether in the first intimate mixture is selected from hydroxyethyl cellulose, hydroxypropyl cellulose, hydroxypropyl methylcellulose, methylcellulose, and carboxymethylcellulose; preferably hydroxypropyl methylcellulose; and wherein the first intimate mixture further comprises a medium or long chain fatty acid salt, preferably a sodium salt or potassium salt or calcium salt of stearic acid.

10. The kit of claim 1, wherein component A optionally further comprises a powder, powder blend or granulate comprising a protein and/or a thickening agent.

11. The kit of claim 1, wherein the second lipid material comprises a triglyceride; and wherein the second water-swellable or water-soluble polymer is selected from a dextrin having a degree of polymerisation from 4 to 40, or from 10 to 30, preferably from 12 to 25; or an inulin having a degree of polymerisation from 4 to 60, or from 5 to 25; and wherein the second ingestible solid formulation contains not more than 5% mucoadhesive polymer.

12. The kit of claim 11, wherein the second lipid material comprises a fractionated but non-hydrogenated palm stearin or palm kernel stearin, and wherein the dextrin is a resistant dextrin derived from wheat or maize starch.

13. The kit of claim 1, wherein optionally the first and/or second ingestible solid formulation further comprises a medium or long chain fatty acid salt, a sugar, a sugar alcohol, an amino acid, a protein, a vitamin, a micro-nutrient and/or a further dietary element incorporated in the first and/or second intimate mixture, respectively.

14. The kit of claim of claim 1, wherein
the protein is an isolate and/or concentrate of a milk protein, a whey protein, a soy protein, a pea protein, a brown rice protein and/or a wheat protein;
the thickening agent is selected from carbomers, agar, gelatine, pectin, carrageenan, alginic acid derivatives, locust bean gum, xanthan gum, tragacanth, chitosan, pullulan, curdlan, psyllium seed husks, wheat-derived dextrins and cellulose derivatives, preferably from carboxymethylcellulose (CMC), xanthan gum or guar gum;
the oil is selected from omega-6 oils such as safflower seed oil, sunflower oil, grape seed oil, wheat germ oil, pumpkin seed oil, evening primrose oil, soy-bean oil, walnut oil or corn oil; from omega-3 oils such as linseed oil (or flaxseed oil), rape seed oil, hemp seed oil, clary sage seed oil, algae oil, Sacha Inchi oil, Echium oil, fish oil, squid oil or krill oil; or combinations thereof;
the amino acid is selected from
(a) L-amino acids;
(b) the group consisting of L-isoleucine, L-valine, L-tyrosine, L-methionine, L-lysine, L-arginine, L-cysteine, L-phenylalanine, L-glutamate, L-glutamine, L-leucine, and L-tryptophan;
(c) the group consisting of L-phenylalanine, L-leucine, L-glutamine, L-glutamate, and L-tryptophan; or
(d) L-tryptophan;
the sugar or sugar alcohol is selected from mono-or disaccharides including sucrose, fructose and glucose, and polyhydric alcohols including arabitol, erythritol, glycerol, isomalt, lactitol, maltitol, mannitol, sorbitol or xylitol:
the medium or long chain fatty acid salt is selected from the salts of capric acid, lauric acid, myristic acid, palmitic acid, stearic acid, arachidic acid, myristoleic acid, palmitoleic acid, sapienic acid, oleic acid, linoleic acid, linolenic acid and eicosapentaenoic acid, preferably a sodium salt or potassium salt or calcium salt of stearic acid, arachidic acid or oleic acid;
the vitamin is selected from retinol, retinal, beta carotene, thiamine, cyanocobalamin, hydroxycyanocobalamine, methylcobalamine, riboflavin, niacin, niacinamide, pantothenic acid, pyridoxine, pyridoxamine, pyridoxal, biotin, folic acid, folinic acid, ascorbic acid, cholecalciferol, ergocalciferol, tocopherol, tocotrienol, phylloquinone, and menaquinone;
the micro-nutrient is selected from organic acids, such as acetic acid, citric acid, lactic acid, malic acid, or taurine; trace- or micro-minerals such as salts of boron, bromine, cobalt, chromium, copper, fluoride, iodine, iron, manganese, molybdenum, selenium, or zinc; choline and cholesterol;
the further dietary element is selected from the macro-minerals calcium, chlorine, magnesium, phosphorous, potassium, sodium and sulphur; and/or
the dietary fibre is selected from a prebiotic or natural gum, cellulose, lichenin, chitin, hemicellulose, or lignin.

15. The kit of claim 1, wherein
component A is provided in a multiple-dose container, optionally equipped with a dosing tool, or in one or more single dose units, or single dose packages; and wherein
component B is provided in one or more single dose units, or single dose packages; and wherein
the single dose unit, or single dose package is selected from vials, ampoules, bottles, sachets, stickpacks foil or plastic bags, or filled straws, or their respective compartments.

16. The kit of claim 15, wherein
component A is provided in a first vial, ampoule or bottle; preferably equipped with a cap housing a reservoir separated from, and optionally connectable to, the inner volume of said first vial, ampoule or bottle; and wherein
component B is provided in said cap reservoir, or in a sachet, stickpack, foil or plastic bag, or filled straw, or in a second vial, ampoule or bottle.

17. The kit of claim 1, wherein a single dose unit, or single dose package, of component A weighs from about 3 g to about 80 g, or from about 3 g to about 60 g, or from about 3 g to about 40 g, or from about 3 g to about 20 g and comprises at least about 2 g of the first lipid material, preferably at least about 3 g of the first lipid material.

18. The kit of claim 1 for use in
the prevention and/or treatment of obesity or a disease or condition associated with obesity;
appetite suppression;
induction and/or prolongation of satiety, and/or body weight reduction;
wherein
the use optionally comprises the oral administration of at least component A at a frequency of at least once a day over a period of at least one week, and wherein optionally
the oral administration of at least component A may be used as a full or partial meal replacement.
